(19) United States
(12) Patent Application Publication
(10) Pub. No.: US 2025/0378193 A1
(43) Pub. Date: Dec. 11, 2025

(54) DOMAIN-SPECIFIC PERSONA GENERATION SYSTEMS AND METHODS

(71) Applicant: Expedia, Inc., Seattle, WA (US)

(72) Inventors: Bogdan Popp, Kirkland, WA (US); Jeffrey Stewart Miller, Seattle, WA (US)

(21) Appl. No.: 18/917,327

(22) Filed: Oct. 16, 2024

Related U.S. Application Data
(60) Provisional application No. 63/656,875, filed on Jun. 6, 2024.

(51) Int. Cl. G06F 21/62

(52) U.S. Cl. CPC G06F 21/6245

(57) ABSTRACT

Systems and methods are provided for data intake of data from an ingestion service indicating a user's online or offline behavior with respect to a domain. A domain persona system may receive a request to access an ingestion service. The domain persona system may then access the ingestion service to obtain the data and identify a subset of the data relevant to the user's online or offline behavior with respect to the domain. The domain persona system may further generate insights with respect to the identified subset and output at least one of the identified subset and the generated insights to a system that updates the domain persona.

### INCORPORATION BY REFERENCE TO ANY PRIORITY APPLICATIONS

This application claims the benefit of U.S. Provisional Application No. 63/656,875, filed Jun. 6, 2024. Any and all applications for which a foreign or domestic priority claim is identified in the Application Data Sheet as filed with the present application are hereby incorporated by reference under 37 CFR 1.57. The entire disclosure of each of the above items is hereby made part of this specification as if set forth fully herein and incorporated by reference for all purposes, for all that it contains.

### TECHNICAL FIELD

The present disclosure relates generally to travel planning. Example implementation and aspects of the present disclosure relate more specifically to generating a domain-specific persona, or domain persona, based on third-party data, or the user's data hosted at one or more third party entities, and user feedback. In further example implementations, the generated domain persona is configured to be used by downstream systems and methods.

### BACKGROUND

Computing devices, along with computing networks, have become ubiquitous and play an integral role in how individuals gather information and complete purchases. For example, a user, via their personal computing device, can interact with network-based information services to search for, review, and share details regarding items in which the user is interested. The versatility of these network-based services allows users to perform these tasks from the comfort of their own homes or offices, and at their own pace and convenience. User interactions may differ with respect to different topics, fields, or domains. For example, a user may have different behavior with respect to travel than with respect to other domains like food or music.

### BRIEF DESCRIPTION OF DRAWINGS

FIG. 1 illustrates a schematic block diagram of an example network environment in which a domain persona system may operate, according to various aspects of the present disclosure;

FIG. 2 is a block diagram of example components of a domain persona system, according to various aspects of the present disclosure;

FIG. 3 is an illustrative diagram representing user identity data including subsets of data from one or more third party data sources, according to various aspects of the present disclosure;

FIG. 4 is a flow diagram for data intake from one or more third party data ingestion services;

FIG. 5 depicts example interfaces for requesting intake of data from one or more specified third party data ingestion services, according to various aspects of the present disclosure;

FIG. 6 depicts example interfaces for receipt and processing of data from one or more third party data ingestion services, according to various aspects of the present disclosure;

FIG. 7A and FIG. 7B depict example interfaces for generating insights with respect to data from one or more third party data ingestion services, according to various aspects of the present disclosure;

FIG. 8 is a flow diagram illustrating a method to merge data from third party data ingestion services with a domain persona representing a specified user with respect to a specified domain, according to various aspects of the present disclosure;

FIG. 9A and FIG. 9B depict example interfaces for viewing and editing data included in a domain persona;

FIG. 10 is a flow diagram illustrating a method to generate recommendations based on a domain persona;

FIG. 11 is a flow diagram illustrating a method to generate travel recommendations based on a travel domain persona; and

FIG. 12 is a block diagram that illustrates a computer system upon which various aspects of the present disclosure may be implemented.

### DETAILED DESCRIPTION

Generally described, the present disclosure relates to generating, maintaining, and using one or more domain personas for each of a plurality of users. A domain persona may be a digital representation of a user in a particular domain, such as travel, food, music, art, shopping, social media use, work, school, and the like, or some combination thereof. The domain persona for a user may be used to improve content presented to a user. Illustratively, a travel domain persona may improve travel recommendations to a user. Travel recommendations based on the domain persona may, for example, reduce time spent by the user on a travel application (e.g., on a smartphone, laptop, desktop, etc.) and provide recommendations better matched to the user's interests (e.g., décor preferences, brands, activities, amenities). This may advantageously save the user time in booking travel and thereby improve their satisfaction with both the recommendation process and with the booked travel.

While in some solutions, entities may retrieve, access, or otherwise pull data from these data sources to generate a user profile, this profile does not provide a domain-specific representation of a user. For example, how a user behaves while shopping at home may be different than the user's behavior with respect to travel. While some data from shopping, such as aesthetic preferences when shopping for furniture or home décor items may be valid, other aspects of a user's shopping data such as purchases of practical items (e.g., cleaning supplies, storage solutions, etc.) when shopping at home may have little bearing on the user's travel preferences. Thus, data that is more relevant to shopping, but has little bearing on travel (e.g., purchases of cleaning supplies, storage solutions, etc.) might still be factored into a profile, which may cause the profiles to be unfocused and therefore less reliable. As another example, how a user behaves with respect to business travel may be entirely different from how they behave with respect to travel with family. Failing to capture or understand differences in user behavior in different domains may reduce the efficacy of downstream machine learning applications (e.g., improved modeling for recommendations, ads/marketing, predictive tools, etc.). Illustratively, generating recommendations for a user conducting business travel based on user data relevant to the entirety of a user's online or offline behavior (e.g., shopping, voting, family-related travel, etc.) may be less accurate, reliable, or effective than recommendations based on data or insights relating to the more limited subject of a user's business travel behavior. In many instances, the more focused a domain is defined, the more effective a persona would be at predicting interests, behavior, outcomes, etc.

Aspects of the present disclosure address the deficiencies described herein with respect to existing techniques by providing a domain persona system, which can access data from a plurality of data sources, such as data portability application programming interfaces (APIs), message parsing systems, data aggregators, first party data (e.g., data owned or controlled by the same entity operating the domain persona system), user provided data (e.g., data provided by the user), third party data (e.g., data collected by the entity operating the domain persona system directly from users), data provider services, and the like, or some combination thereof. Illustratively, the domain persona system may leverage data relating to a user's online or offline behavior from data sources that provide core services like online search engines, app stores, messengers, social media sites (also referred to herein as “third party data ingestion services”). These data sources may make a large amount of data available relating to one or more users, and this data can be indicative (e.g., in combination with first party data or data already collected by a domain persona system or related entity) of different facets (also referred to herein as “domains”) of each of the users online or offline presence including, but not limited to, travel, food, music, art, shopping, social media use, work, school, and the like, or some combination thereof. Using this data (e.g., and/or other data already collected), the domain persona system can generate one or more domain personas corresponding to each user with respect to one or more corresponding domains, as described herein.

Illustratively, the domain persona system may draw insights from the accessed data with respect to the particular domain for a specified user, where insights represent conclusions drawn regarding a user's behavior, preferences, perspectives, interests, and the like, or some combination thereof, with respect to the particular domain. The domain persona system may, in some examples, generate insights to incorporate into a user's domain persona (with or without the user's review, approval, or feedback). The raw data and/or generated insights, may be stored as part of domain personas generated by the domain persona system. The domain personas may then be used in downstream machine learning application, such as to predict a user's behavior with respect to a particular domain.

Domain personas can be generated for multiple users, and each user can have multiple domain personas. Each domain persona may represent the user in different domains including, but not limited to, travel, food, music, art, shopping, social media use, work, school, and the like, or some combination thereof. Illustratively, a user may have different domain personas with respect to travel than with respect to, food, music, art, shopping, social media use, work, school, and the like, or some combination thereof. The user may additionally, or alternatively, have different domain personas with respect to different purposes within a broader domain. Illustratively, a user may have a different domain persona with respect to business travel than with respect to leisure travel including, but not limited to, family-related travel, solo travel, travel with friends, or the like. A user may, in some examples, have different domain personas for different types of leisure travel, such as a family-related travel persona, a solo travel persona, a friend-related travel persona, etc. With respect to business travel, for example, a user may largely limit their travel to locations where their employer has offices, or they may book business class tickets. In contrast, with travel relating to family, the user may travel to a variety of destinations, the destinations may include more kid-friendly attractions, they may book larger or additional rooms to accommodate kids, and/or they may book flights in coach.

In generating a domain persona, a domain persona system may be used. The domain persona system, when generating a domain persona for a particular user with respect to a particular domain, may consider the particular user's interactions, actions, and/or subjective preferences relevant to a particular domain (e.g., from a larger set of data that may pertain to broader categories). Illustratively, the domain persona system may process raw data including indications of a user's behavior with respect to the particular domain in order to derive insights, where the insights may be observations from user data. For example, the domain persona system may draw insights from the raw data, such as the frequency of visits to museums, and the type of museums visited (e.g., art museums, science museums, natural history museums, etc.). The domain persona system may additionally, or alternatively, generate more complex insights from the raw data or initially generated insights (e.g., that the user likes visiting art museums). The raw data and/or generated insights may be stored as part of the domain persona. The generated domain persona may then be used by downstream machine learning applications, such as to improve content provided to the user.

For example, a generated travel domain persona may include data and insights related to one or more of: a user's prior bookings (e.g., hotels, cars, locations, dates, etc.), a user's social media usage with respect to travel destinations (e.g., images of locations, dates and times associated with any posts, likes, comments, etc.), derived user preferences with respect to aesthetics (e.g., preferred colors, preferred home décor style, preferred fashion styles, preferred animals, preferred flowers, etc.), derived user preferences with respect to travel (preferred travel destinations, preferred hotels, preferred vehicle types, etc.), changes to a user's interests with respect to travel (e.g., changes with respect to preferred travel destinations, preferred hotels, preferred vehicle types, etc.), changes to a user's interests with respect to aesthetics (e.g., changes with respect to preferred colors, preferred home décor style, preferred fashion styles, preferred animals, preferred flowers, etc.), and the like. The domain persona may include structured data and/or unstructured data and include actions taken by a user online (e.g., bookings, purchases, clicks, etc.), actions taken by a user offline (e.g., visits to museums, banks, etc.), and subjective preferences determined from a user's behavior (e.g., actions) online or offline that may be relevant to the domain (e.g., a user's favorite color, a user likes museums, etc.).

Illustratively, data derived from a specified user's online or offline behavior may show that the user frequently purchases home décor items corresponding to an art deco style. In generating a domain persona, such as a travel domain persona, the domain persona system may draw an insight from this shopping data showing that the user purchases many art deco items, where insights indicate user preferences, interests, or the like. The domain persona system may also draw further insights from the raw data or from initially drawn insights (e.g., that the specified user enjoys the art deco style). Then, travel options that include the art deco style can be ranked higher in a list of potential options for the user to select from when the user plans for travel. In some examples, the domain persona system may confirm the insights with each user (e.g., for accuracy, correctness, completeness, etc.). Generated insights (including those insights that were updated based on user feedback) may be stored as part of, or integrated with, the travel domain persona for the specified user.

After generation, or updates, based on data derived from the specified online or offline behavior, the travel domain persona may be used in downstream machine learning models including, but not limited to, training or fine tuning machine learning models (e.g., improved modeling for recommendations), crafting better prompts for GenerativeAI services, ads/marketing, predictive tools, and the like, or some combination thereof. With continued reference to the illustrative example, based on the generated insight that the user enjoys art deco, a machine learning model for generating travel recommendations, may recommend hotels decorated in an art deco style, travel locations including attractions (e.g., buildings) in an art deco style, and the like, or some combination thereof.

Reliability of the data and generated insights forming the basis of each domain persona improves the quality of the respective domain persona. As one example, the more data that is available, the more reliable the domain persona may be. Increasing the amount of available data may be accomplished, for example, by incorporating data from a variety of data sources. Illustratively, the domain persona system may intake data relating to a user's online or offline behavior from a variety of sources, such as search providers (e.g., Google, Bing, etc.), social media sites (e.g., Facebook, Twitter, etc.), shopping platforms (e.g., Amazon, etc.), message parsing services, data analysis tools (e.g., LiveRamp, etc.), touchpoints (e.g., banks, retail locations, credit bureaus, etc.), and the like, or some combination thereof.

Other factors that can improve the reliability of a domain persona may include quality of data available. Quality of data may be improved, for example, by decreasing the likelihood of fraudulent data (e.g., fake accounts, etc.), increasing the relevance of data incorporated into a domain persona, and the like, or some combination thereof. In some examples, the domain persona system of the present disclosure may employ a fraud detection service (inside or outside the domain persona system) to reduce the risk of incorporating fraudulent data into a generated domain persona, such as through analysis of the age of data, amount of data, and the like, or some combination thereof. Illustratively, the fraud detection service may determine that a social media account within which a threshold percentage of data shares a timestamp has a likelihood of fraud above a threshold. The fraud detection service may additionally, or alternatively determine that the social media account has a likelihood of fraud above a threshold if the social media account includes an amount of data below a specified threshold. If the fraud detection service determines that the social media account has a likelihood of fraud above a threshold, the fraud detection service may exclude the data corresponding to the social media account.

With respect to improving relevance, data relevant for a particular user may be derived from one or more of these data sources and then processed to use a portion of the accessed data for one or more specified domains pertaining to the particular user. The domain persona system may employ a relevancy service (inside or outside the domain persona system), which may score each data item and/or insight for relevance with respect to the user's behavior, perspectives, preferences, interests, or the like, with respect to a specified domain.

The domain persona system may, in some aspects, also improve relevance by providing the user with the ability to provide feedback. Illustratively, a user may indicate whether a generated insight is actually reflective of their preferences, perspective, interests, or the like, with respect to the domain. For example, when presented with an insight that the user likes South Indian restaurants, the user may instead indicate that they prefer North Indian restaurants.

Incorporating user input, such as feedback on data incorporated into the domain persona, also improves users' access and transparency over their data. This allows users to make informed decisions, such as whether to grant or withhold consent to their data. The making of informed decisions may further increase a user's trust and confidence in the system. In some aspects of the present disclosure, a user may be compensated, such as for authorizing access to their data in third party data ingestion services and for provision of feedback to improve relevance. The user may, for example, receive compensation of a portion of the revenue derived from their data by the domain persona system, a portion of the revenue from use of their data in downstream machine learning applications, and the like, or some combination thereof.

The above-described aspects and other aspects of the disclosure will now be described with regard to certain examples, embodiments, and aspects, which are intended to illustrate but not limit the disclosure. Although the examples, embodiments, and aspects described herein will focus on, for the purpose of illustration, specific methodology an applications of domain personas, one of skill in the art will appreciate the examples are illustrative only and are not intended to be limiting.

### 1. Example Network and or Operating Environment

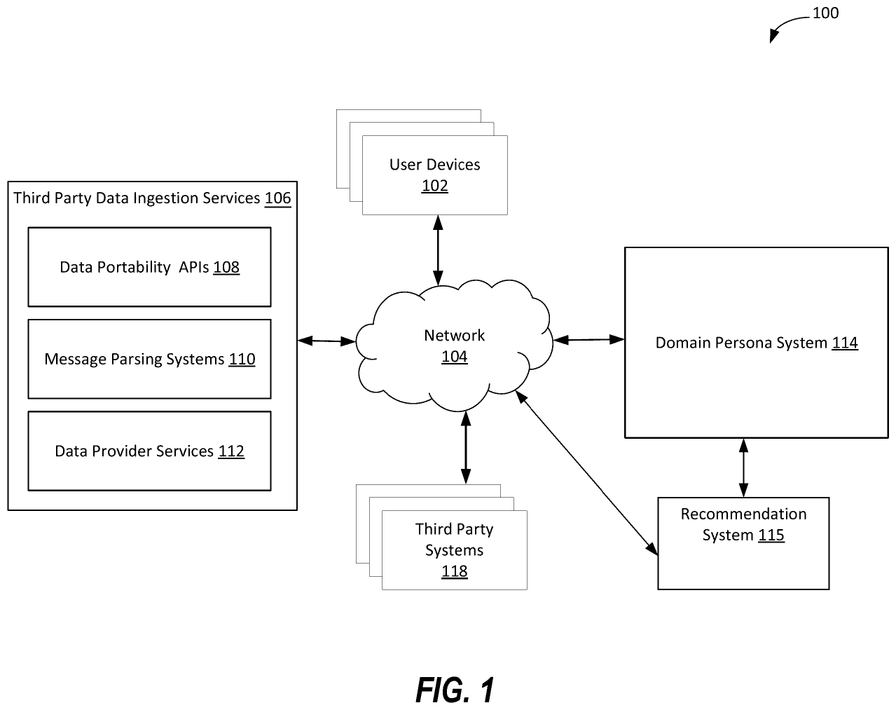

FIG. 1 illustrates a schematic block diagram of an example network environment 100 in which a domain persona system may operate, according to various aspects of the present disclosure. The domain persona system 114 may receive or obtain raw data, such as raw data representative of user behavior, from third party data ingestion services 106 through network 104. Based on data from the third party data ingestion services 106, the domain persona system 114 may subsequently generate or update a domain persona representing a specified user's behavior in a specified domain. Illustratively, the domain persona system 114 may coordinate with the specified user through user devices 102 in order to determine a subset of data from the raw data and incorporate the subset of data from third party data ingestion service 106 to update or generate the domain persona. When generating or updating the domain persona, the domain persona system 114 may provide the domain persona for use in downstream machine learning applications. For example, the domain persona system may provide the domain persona for use by the recommendation system 115 and/or third party systems 118.

In various aspects, communication among the various components of the example network environment 100 may be accomplished via any suitable device, systems, methods, and/or the like. Further details and examples regarding the implementations, operation, and functionality of the various components of the domain persona system 114 and the example environment 100 are described herein in reference to various figures.

### 1.1. Domain Persona System

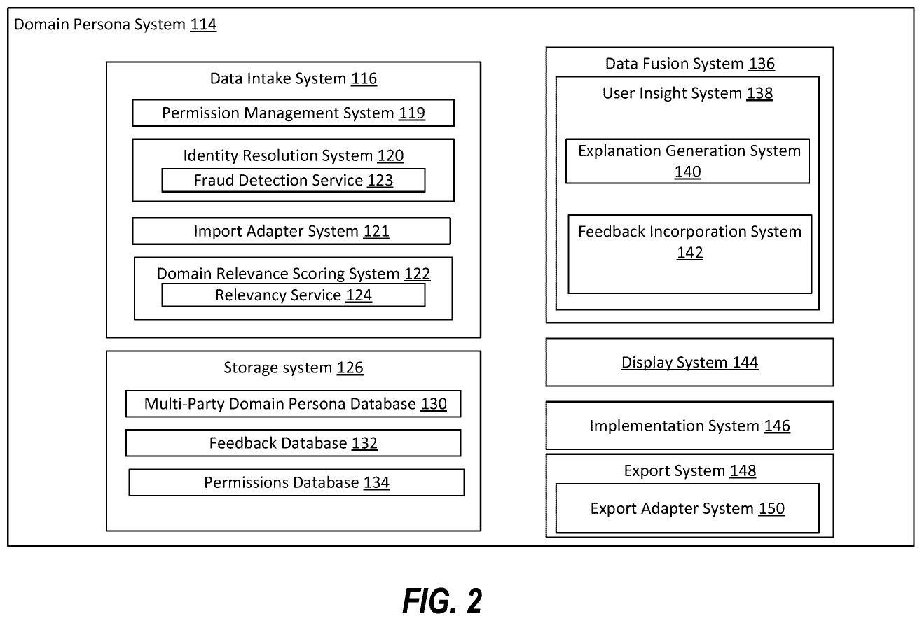

The domain persona system 114 may generate or update domain personas. Example components of the domain persona system 114 will be described in more detail with respect to FIG. 2. Each domain persona may represent a specified user's behavior, preferences, perspectives, insights, or the like, in a particular domain, such as travel, food, music, art, shopping, social media use, work, school, and the like, or some combination thereof. In order to generate or update a particular domain persona, the domain persona system may leverage input from users through user devices 102 and/or data from third party data ingestion services 106. Example components of the domain persona system 114 will be described in more detail with respect to FIG. 2.

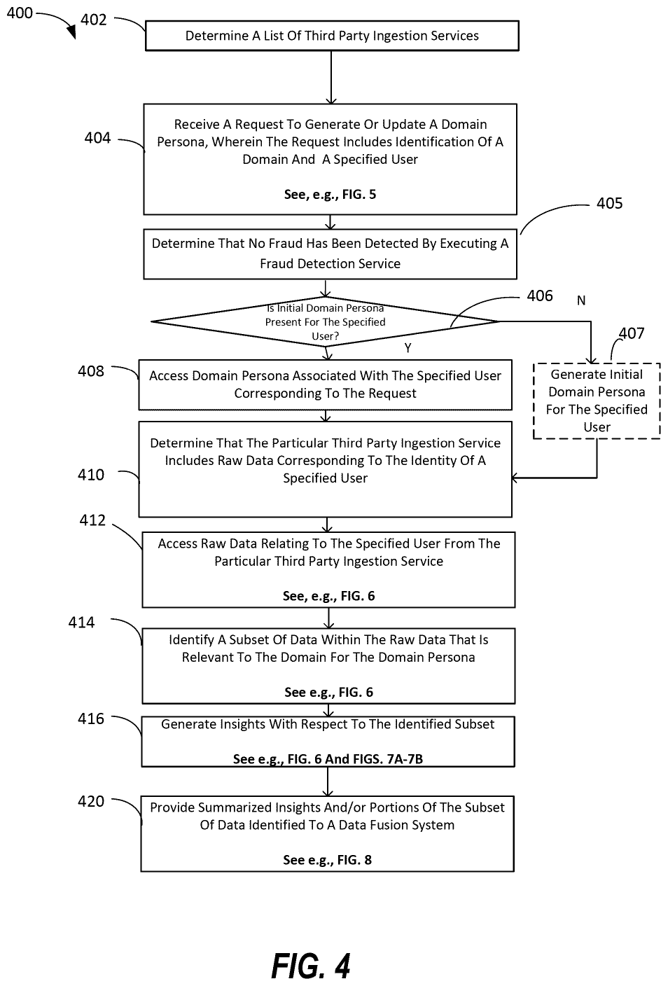

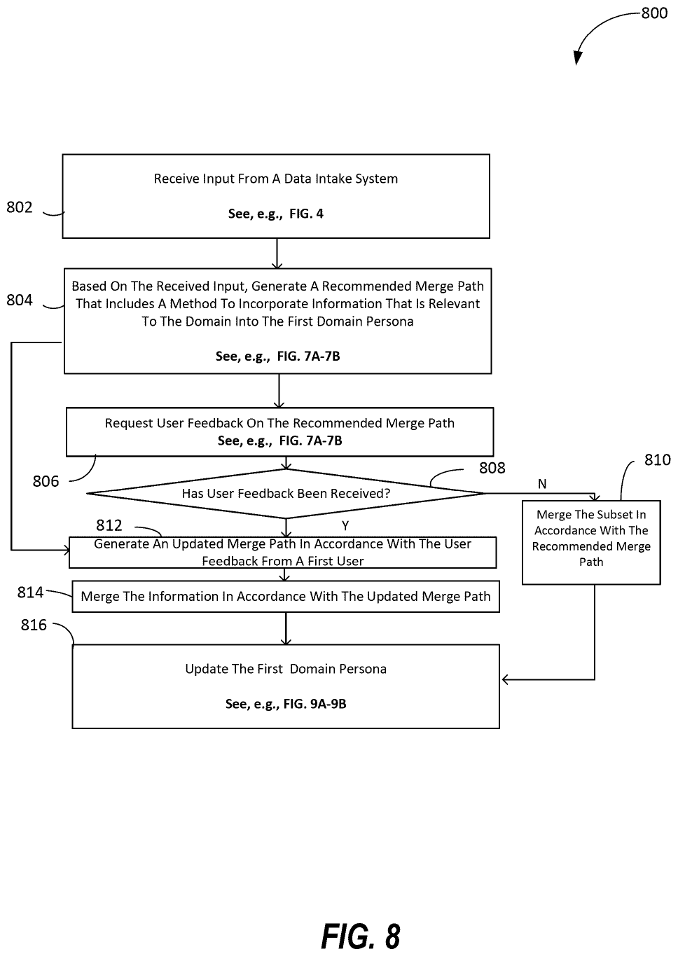

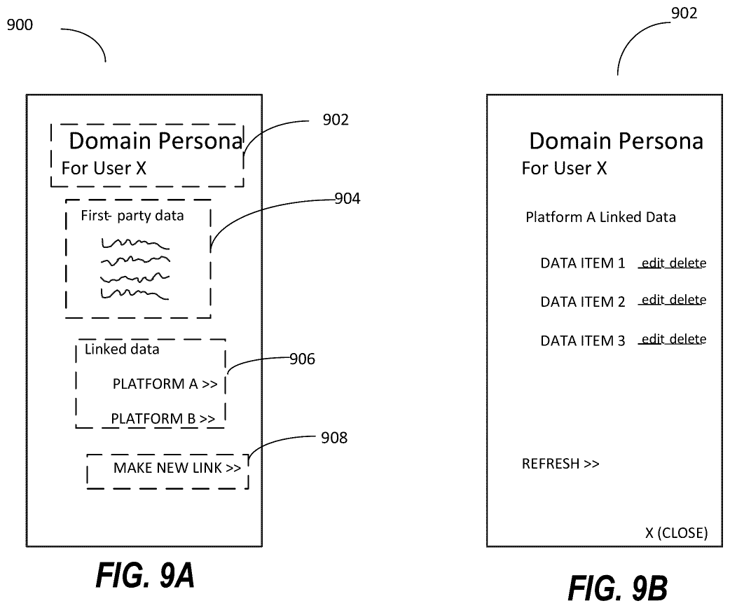

Illustratively, the domain persona system 114 may incorporate user input by requesting access, and/or authorization to access, data from third party data ingestion services 106. The domain persona system 114 may further leverage user input to confirm how raw data obtained from the third party data ingestion services 106 may be incorporated into a specific domain persona (e.g., travel domain persona) for the user. As will be described in more detail with respect to FIGS. 4-7B, the domain persona system 114 may generate insights based on a subset of raw data determined to be relevant with respect to the domain and a specified user. The domain persona system 114 may further summarize the generated insights for presentation (e.g., as a list of written text, images, audio, or the like) to the specified user for feedback or approval. As will be described in more detail with respect to FIGS. 8-9B, for example, the domain persona system 114 may generate a recommended method to incorporate the subset of the raw data (e.g., the relevant user data identified for a particular domain) and/or generated insights (e.g., initial insights determined based on the subset of raw data, insights determined based on the initial insights, and the like, or some combination thereof) into the domain persona and request user input from the specified user on the recommended method. The specified user may provide the requested input to domain persona system 114 through one or more user devices 102.

### 1.2. Example User Devices

User devices 102 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. The domain persona system 114 may provide the user device(s) 102 with one or more user interfaces, command-line interfaces (CLIs), APIs, and/or other programmatic interfaces for generating and uploading user-executable code, invoking the user-provided code, scheduling event-based jobs or timed jobs, tracking the user-provided code, and/or viewing other logging or monitoring information related to their requests and/or user code, such as by utilizing display system 144. Although one or more examples may be described herein as using a user interface, it should be appreciated that such examples may, additionally, or alternatively, use any CLIs, APIs, or other programmatic interfaces.

### 1.3. Example Network

Network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some examples, the network 104 may be a private or semi-private network, such as a corporate or university intranet. The network 104 may include one or more wireless networks, such as a Global System for Mobile Communications (GSM) network, a Code Division Multiple Access (CDMA) network, a Long Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

### 1.4. Third Party Data Ingestion Services

Third party data ingestion services 106 may include systems and services relating to collecting, compiling, transmitting, and/or parsing user data. Third party data ingestion services 106 may include data portability APIs 108, message parsing systems 110, and data provider services 112. In some examples, third party data ingestion services 106 may include more or fewer systems and services. The third party data ingestion services 106 may, for example, omit data provider services 112. As another example, the third party data ingestion services 106 may additionally include web analytics tools, such as web analytics tools that track website traffic patterns.

As will be described in more detail herein, and with respect to FIGS. 4-7B, the domain persona system 114 may, in some examples, access data from one or more of third party data ingestion services 106 in creating or updating a domain persona representing a user's behavior in a specified domain. Illustratively, the domain persona system 114 may request data corresponding to a specified user, such as data including a specified user identifier as metadata from any of third party data ingestion services 106. The process of making the request may involve requesting and receiving authorization from the specified user to access data collected by their respective entity that corresponds to the specified user. The third party data ingestion service to which the request is directed (e.g., data portability APIs 108, message parsing systems 110, and data provider services 112) may then provide the domain persona system 114 with the data collected by their respective entity that corresponds to the specified user.

Domain persona system 114 may additionally, or alternatively, request data from other sources. A particular user (e.g., through a user device 102) may, for example, request that the data portability APIs 108 provide the domain persona system 114 access to data corresponding to the particular user, such as data including a particular identifier as metadata. The particular user may, in some examples, authorize access to a subset of data including a particular identifier from a particular third party data ingestion service 106. The particular third party data ingestion service 106 may illustratively segment data into types, such as segmenting search data by domains including, but not limited to, travel, food, music, art, shopping, social media use, work, school, and the like, or some combination thereof. The particular user may allow the domain persona to access a subset of the search data, such as travel related search data, shopping related search data, and social media related search data. For example, the particular user may allow the domain persona to access by selecting the accessible domains through an interface presented on a user device 102.

### 1.4.1. Data Portability APIs

Data portability APIs 108 may correspond to an entity or entities that collect large amounts of data, such as Google, Meta, or the like. A general search related entity (e.g., Google, Bing, etc.) may, for example, collect data including, but not limited to, search frequency, conducted searches, click data with respect to the results of the conducted searches, and the like, or some combination thereof. A social media entity (e.g., Meta, LinkedIn, etc.) may, for example, collect data including, but not limited to, likes, follows, posts, selected advertisements, and the like, or some combination thereof. A shopping related entity may for example, collect data including, but not limited to, searched for items, purchased items, returned items, and the like, or some combination thereof. Each entity may store the collected data, such as in one or more data stores accessible through data portability APIs 108.

Illustratively, the entities may each have their own data portability API 108 that can be leveraged by users or third parties (e.g., the domain persona system 114) to provide data responsive to requests, such as by accessing data stores including the collected data for the entity associated with the respective data portability API 108. A user may, for example, provide credentials to allow access to a data portability API 108, such as through domain persona system 114. The provision of credentials may be part of a request to export data from the data stores of an entity with a respective data portability API 108. The request may, in some examples, include parameters such as specification of a time period (e.g., a date range, business hours, etc.) desired data format (e.g., JSON object, CSV, portable network graphic (PNG), etc.), and/or specific data types (e.g., travel search data, social media use data, shopping data, etc.). The respective data portability API 108 may package the data into the desired data format for export, such as by creating a zip file of the data in the desired data format (e.g., JSON object, CSV, portable network graphic (PNG), etc.). The data portability API 108 may then export the data to the requestor, such as the domain persona system 114.

### 1.4.2. Message Parsing Systems

Message parsing systems 110 may be systems that have access to email or messaging services associated with users. Illustratively, a user may authorize a particular message parsing system 110, such as through domain persona system 114, to access an email account associated with the user. The provision of credentials may be part of a request to parse emails in the email account and export data derived from parsing the emails. The particular message parsing system 110 may, for example, be configured to parse a certain type of data from the emails in the email account including, but not limited to, data relating to travel, food, music, art, shopping, social media use, work, school, and the like, or some combination thereof. The request may, in some examples, include parameters such as specification of a time period (e.g., a date range, business hours, etc.), a desired data format (e.g., JSON object, CSV, portable network graphic (PNG), etc.), and/or specific data types for extraction (e.g., travel search data, social media use data, shopping data, etc.) The particular message parsing system 110 may, in further examples, parse the email to extract the requested data. After extracting the requested data, the particular message parsing system 110 may package the data into the desired data format indicated in the request (e.g., by creating a zip file of the data in the desired data format). The particular message parsing system 110 may then export the data to the requestor, such as the domain persona system 114.

### 1.4.3. Data Provider Services

Data provider services 112 may include, but are not limited to, services that provide integrated solutions connecting data between data sources. For example, data provider services 112 may divide collected data into segments based on demographics, interests, and behaviors. Data provider services 112 may additionally, or alternatively, measure the impact of marketing decisions made by various entities. A user may, for example, provide credentials to allow access to a data corresponding with the user (e.g., including a unique identifier to the user) in a particular data provider service 112, such as through domain persona system 114. The provision of credentials may be part of a request to export data from the particular data provider service 112. In some examples, the data may be exported in a default format e.g., JSON object, CSV, portable network graphic (PNG), etc.).

The request may, in some examples, include parameters such as specification of a time period (e.g., a date range, business hours, etc.), desired data format (e.g., JSON object, CSV, portable network graphic (PNG), etc.), and/or specific data types (e.g., travel search data, social media use data, shopping data, etc.). The particular data provider service 112 may package the data into the desired data format for export, such as by creating a zip file of the data in the desired data format (e.g., JSON object, CSV, portable network graphic (PNG), etc.). The data portability API 108 may then export the data to the requestor, such as the domain persona system 114.

### 1.5. Recommendation System

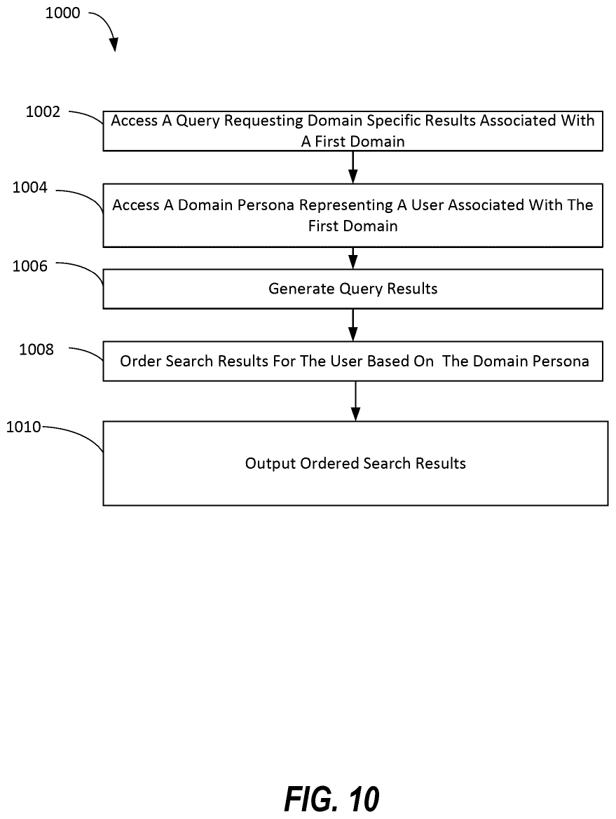

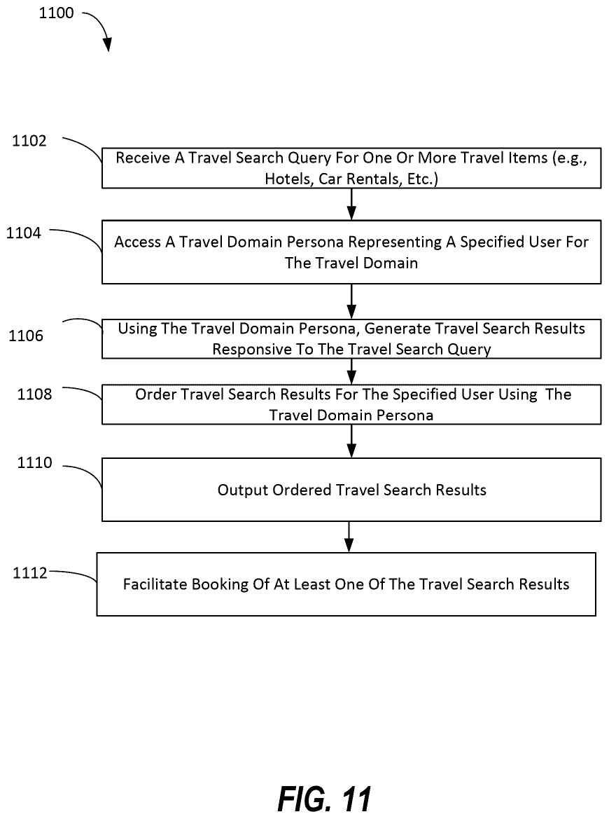

Once a particular domain persona has been generated, the domain persona system 114 may make generated domain personas accessible to downstream machine learning applications. For example, the domain persona system 114 may provide a domain persona or domain personas to the recommendation system 115. The recommendation system 115 may be any system that provides search results, recommendations, reviews, the like, or some combination thereof. The recommendation system 115 may utilize the domain persona to recommend search results for a specific domain, such as the travel domain. Use of domain personas by downstream machine learning applications will be described in more detail herein with respect to FIGS. 10-11.

As one example, a particular user may submit a query for “clocks” on a shopping platform corresponding to a recommendation system 115. The recommendation system 115 may employ a downstream machine learning application for recommendations. The particular user's shopping domain persona may include an insight that they like pink. Accordingly, in response to the particular user's shopping query for clocks, the third party system 118 may recommend listings including pink clocks to the particular user.

As another example, a particular user may illustratively submit a travel query to a recommendation system 115. A travel domain persona may exist for the particular user. Recommendation system 115 may leverage the travel domain persona with a downstream machine learning application to generate results to the query and/or order the results of the query for presentation to the user. For example, the recommendation system 115 may be a travel search platform and can be configured to access a generated travel domain persona in real time and/or as needed, such as when the specified user is searching for travel on the search platform. Illustratively, the recommendation system 115 may access the generated travel domain persona at a variety of time intervals (e.g., instantly, less than 1 second, etc.) after receipt of a travel query from a specified user. The recommendation system 115 may then use the travel domain persona to generate results responsive to the travel query, as described herein. Illustratively, a particular user's travel domain persona may include the insight that the particular user likes to visit art museums. The user may submit a travel query for hotels in Seattle. Based on the insight included in the user's travel domain persona, the downstream machine learning application for the recommendation system 115 may rank hotels closer to art museums higher on a list of results presented to the particular user. The recommendation system 115 may additionally, or alternatively, select a subset of hotels close to art museums as results responsive to the submitted travel query.

The recommendation system 115 may additionally, or alternatively, determine a presentation for search results based on the travel domain persona. Illustratively, in response to a query for hotels in Seattle, the recommendation system 115 may highlight content corresponding to the results set for presentation. The recommendation system 115 may, for example, highlight portions of textual descriptions (e.g., descriptions on the hotel's website, reviews, and the like, or some combination thereof) of the hotels in the results set. The recommendation system 115 may, as another example, select an image to display as results responsive to the submitted travel query. With continued reference to the illustrative example, responsive to the particular user's query for hotels in Seattle, the recommendation system 115 may present imagery including, but not limited to, an image of the most relevant hotel presented in the results list, an image for all hotels presented in the results list, maps indicating the hotels with respect to surrounding art museums, and the like, or some combination thereof.

The recommendation system 115 may also interact with the user based on their domain persona. Illustratively, the recommendation system 115 may be a travel search provider, which may facilitate search and purchase of various travel items, such as hotels, vehicle rentals, and the like, or some combination thereof. With continued reference to the illustrative example, a particular user's travel domain persona may indicate that they like art museums. When the particular user accesses the recommendation system 115 (e.g., through a browser, through an app, and the like, or some combination thereof), the recommendation system 115 may present the user with images of one or more travel destinations with a large number of art or art museums, such as Seattle, Washington DC, Rome, and the like. The recommendation system 115 may additionally, or alternatively, present the user with recommended searches for identified destination(s) with a large number of art museums. By way of example, the recommendation system 115 may present an app home page or website home page to a user including recommended searches for the identified travel destination(s) as example text in a user-fillable text box for searches.

The recommendation system 115 may, in some examples, influence topics of conversation with and nature of responses from a chatbot. With continued reference to the prior example, the recommendation system 115 may be a travel search platform. The recommendation system 115 may, in further examples, provide a chat bot (e.g., through an app, through website, etc.) for interaction with users. The particular user of the illustrative example, may communicate with the chat bot. The particular user may, for example, request that the chatbot suggest travel destinations. The chatbot may respond with destination(s) with a large number of art museums.

The particular user may, as another example, communicate with the chatbot as a help center with regards to specific questions about a trip. Illustratively, the particular user may request that the chatbot provide the contact information for various hotels, nearby attractions (e.g., art museums, landmarks, etc.), restaurants in the area, and the like, or some combination thereof. The chatbot may utilize the travel domain persona for the particular user to respond to these questions. For example, in response to the particular user's query for nearby attractions, the chatbot of the recommendation system 115 may respond with a list of nearby art museums. The recommendation system 115 may, as another example, adapt a reference guide.

### 1.6. Third Party Systems

Third party systems 118 may also leverage domain personas for use in downstream machine learning applications, such as for predicting a specified user's behavior in a specified domain. As a further example, the third party systems 118 may then use the predicted behavior to present items, such as travel items, household goods, news articles, and the like, or some combination thereof, to the specified user represented by the domain persona. In some examples, the third party systems 118 can influence a selection of an initial results set, determine results for presentation (e.g., to an end user), interact with a user (e.g., to provide search suggestions, as a chatbot, and the like, or some combination thereof).

As one example, a particular user may be browsing on a shopping platform corresponding to a third party system 118. The third party system 118 may employ a downstream machine learning application for advertisement. The particular user's shopping domain persona may include insights that they like pink and they like clocks. Accordingly, the third party system 118 may present the particular user with advertisements for pink clocks.

As another example, a particular user may illustratively submit a travel query to a third party system 118. A travel domain persona may exist for the particular user. The third party system 118 may leverage the travel domain persona with a downstream machine learning application to generate results to the query. Illustratively, a particular user's travel domain persona may include the insight that the particular user likes to visit art museums. The user may submit a travel query for hotels in Seattle. Based on the insight included in the user's travel domain persona, the downstream machine learning application for the third party system 118 may select a subset of hotels close to art museums as results responsive to the submitted travel query.

The third party system 118 may additionally, or alternatively, determine a presentation for search results based on the travel domain persona. Illustratively, in response to a query for hotels in Seattle, the third party system 118 may highlight content corresponding to the results set for presentation. The third party system 118 may, for example, highlight portions of textual descriptions (e.g., descriptions on the hotel's website, reviews, and the like, or some combination thereof) of the hotels in the results set. The third party system 118 may, as another example, select an image to show in a results set. With continued reference to the illustrative example, responsive to the particular user's query for hotels in Seattle, the third party system 118 may present imagery including, but not limited to, an image of the most relevant hotel presented in the results list, an image for all hotels presented in the results list, maps indicating the hotels with respect to surrounding art museums. and the like, or some combination thereof.

The third party system 118 may also interact with the user based on their domain persona. Illustratively, the third party system 118 may be a travel search provider which may facilitate search and purchase of various travel items, such as hotels, vehicle rentals, and the like, or some combination thereof. With continued reference to the illustrative example, a particular user's travel domain persona may indicate that they like art museums. When the particular user accesses the third party system 118 (e.g., through a browser, through an app, and the like, or some combination thereof), the third party system 118 may present the user with images of one or more travel destinations with a large number of art or art museums, such as Seattle, Washington DC, Rome, and the like. The third party system 118 may additionally, or alternatively, present the user with recommended searches for identified destination(s) with a large number of art museums. By way of example, the third party system 118 may present an app or website home page to a user including recommended searches for the identified travel destination(s) as example text in a user-fillable text box for searches.

The third party system 118 may, in some examples, influence topics of conversation with and nature of responses from a chatbot. With continued reference to the prior example, the third party system 118 may be a travel search platform. The third party system 118 may, in further examples, provide a chat bot (e.g., through an app, through website, etc.) for interaction with users. The particular user of the illustrative example, may communicate with the chat bot. The particular user may, for example, request that the chatbot suggest travel destinations. The chatbot may respond with destination(s) with a large number of art museums. The particular user may, as another example, communicate with the chatbot as a help center with regards to specific questions about a trip. Illustratively, the particular user may request that the chatbot provide the contact information for various hotels, nearby attractions (e.g., art museums, landmarks, etc.), restaurants in the area, and the like, or some combination thereof. The chatbot may utilize the travel domain persona for the particular user to respond to these questions. For example, in response to the particular user's query for nearby attractions, the chatbot of the third party system 118 may respond with a list of nearby art museums.

Use of domain personas by downstream machine learning applications, such as third party systems 118, will be described in more detail herein with respect to FIGS. 10-11.

### 2. Domain Persona System

FIG. 2 is a block diagram of example components of a domain persona system 114, according to various aspects of the present disclosure.

The general architecture of the domain persona system 114, as described in FIG. 2, includes an arrangement of logical elements that may be used to implement one or more aspects of the present disclosure. Domain persona system 114 may include many more (or fewer) elements than those shown in FIG. 2. It is not necessary, however, that all of these elements be shown in order to provide an enabling disclosure.

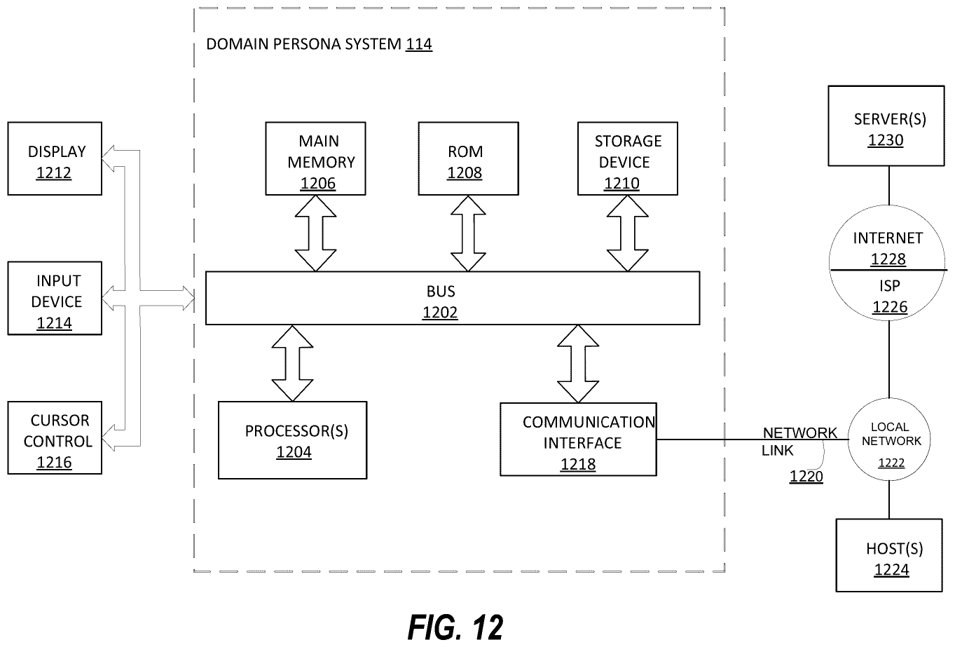

As illustrated in FIG. 2, the domain persona system 114 includes a data intake system 116, storage system 126, data fusion system 136, display system 144, implementation system 146, and export system 148. The illustrated elements may be implemented as software on the same hardware device, implemented on distributed computing devices, or some combination thereof, as will be described in more detail with respect to FIG. 12.

### 2.1. Storage System

Storage system 126 may include, but is not limited to, RAM memory, flash memory, ROM memory, EPROM memory, EEPROM memory, registers, hard disk, a removable disk, a CD-ROM, or any other form of non-transitory computer-readable storage medium. As illustrated in FIG. 2, the storage system 126 includes multi-party domain persona database 130, feedback database 132, and permissions database 134. In some examples, the storage system 126 may include more, or fewer (e.g., one database), discrete databases. For example, the permissions database 134 may be included in the permission management system 119. As another example, the storage system 126 may include a discrete database for relevance scoring results. Use of storage system 126 by components of domain persona system 114 will be described in more detail herein and with respect to FIGS. 4-7B.

Data included in the storage system 126 may include, but is not limited to, data from third party data ingestion services 106, data accessible through an internal network, and the like, or some combination thereof. Illustratively, the domain persona system 114 may be co-owned by an entity also including ingestion services (“co-owned entities” for brevity) For example, the domain persona system and the search platform may share an administrator. The domain persona system 114 may therefore have access to the search platforms data through an internal network. In some examples, separate storage systems may be accessible through this internal network, which may be used when manipulating the data to generate domain personas. This may advantageously lessen the amount of computing resources required by the domain persona system 114. Additionally, or alternatively, fewer permissions may be required to handle data from co-owned entities. This may also advantageously lessen the amount of computing resources required by the domain persona system 114.

Data stored in the storage system 126 may be manipulated during the process of generating domain personas for one or more users. Illustratively, data from a particular third party data ingestion service 106 may be added after a particular user provides authorization to access the third party data ingestion service 106. Each third party data ingestion service 106 may include a large dataset of data corresponding to a particular user with respect to a particular domain. Accordingly, the domain persona system 114 may need to download large amounts of data (e.g., to storage system 126) when generating a domain persona. Large datasets may be hard to download and expensive to store, so better ways are needed to handle data.

In some examples, the domain persona system 114 may determine a relevant subset of data for a user with respect to a domain prior to downloading the data from a third party data ingestion service 106. This may advantageously reduce latency in downloading the data and lessen the amount of computing resources required to store and process the data.

In some examples, all authorized data may be stored in storage system 126, such as to a temporary memory (e.g., RAM) of the storage system 126. As will be described herein, the data from third party data ingestion services 106 may be processed to determine a subset of relevant data and generate insights with respect to at least one domain, where insights represent conclusions drawn by the domain persona system 114 on a user's behavior, preferences, perspectives, interests, or the like, with respect to a domain. Multiple relevant subsets may be derived from downloaded data, such as subsets determined to be relevant to a user's behavior, preferences, perspectives, interests, or the like, with respect to each of multiple different domains.

In some examples, during generation of a domain persona or personas, data may be manipulated, such as by deleting data not included in a relevant subset, deleting all data except insights, and the like, or some combination thereof.

### 2.1.1. Multi-Party Domain Persona Database

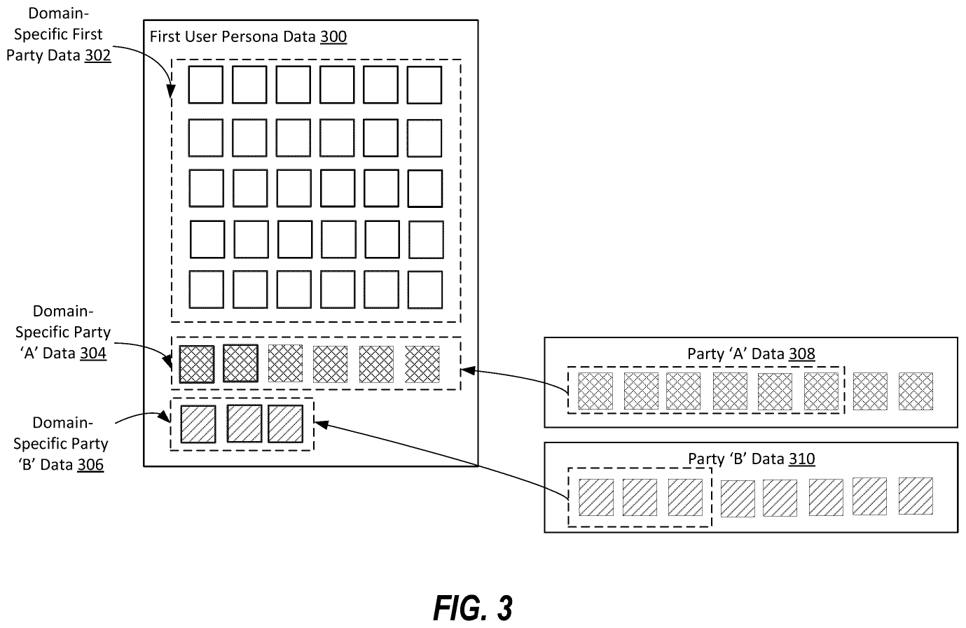

The multi-party domain persona database 130 may include generated domain personas representing behavior, perspective, preferences, interests, or the like, of one or more users with respect to a particular domain and/or multiple domains. The domain personas may include structured data, unstructured data, or some combination thereof. Accordingly, domain personas may be stored in a variety of structures including, but not limited to, a SQL table, a NoSQL data structure (e.g., a JavaScript Object Notation (JSON) database, MessagePack, etc.). Storage of domain personas will be described further with respect to FIG. 3. Generation of domain personas will be described further herein with respect to FIGS. 4-9B.

### 2.1.2. Feedback Database

The feedback database 132 may store interactions with a user in processing a user's data, generating insights with respect to a specified domain (e.g., regarding a user's behavior, preferences, perspectives, insights, etc.), and/or generating or updating a domain persona for the user. The user feedback may include feedback authorizing the domain persona system 114 to access a third party data ingestion service 106, feedback on the relevance of data for incorporation into a domain persona, feedback on the accuracy of generated insights with respect to the user's behavior, preferences, perspectives, interests, or the like, or some combination thereof, with respect to a domain.

Interacting with the user during data intake advantageously allows the user to have transparency and control into the data that is being incorporated into their domain persona. The user may, in some examples, provide feedback as to the relevance of the data that may be accessed by the domain persona system 114, feedback as to which data may be accessed by the domain persona system 114, and the like, or some combination thereof. Incorporation of user feedback may advantageously improve the quality of a domain persona, such as by improving the accuracy of data incorporated by the domain persona. In one example, a user may have knowledge that they have not used a particular third party data ingestion service 106 for a number of years. Because the user has not used the particular third party data ingestion service 106 for a number of years, the data may not be as relevant to the user's current behaviors, preferences, insights, and the like, or combination thereof, with respect to a domain (e.g., particular domain, such as travel, food, music, art, shopping, social media use, work, school, and the like, or some combination thereof). Receiving user feedback denying access to the particular third party data ingestion service 106 may thereby improve quality of the domain persona at least by excluding data that may not be as relevant to the user's current behaviors, preferences, insights, and the like, or combination thereof, with respect to a domain.

As another example, a user may have knowledge that they do not use a particular third party data ingestion service 106. In other words, data corresponding to the user in the particular third party data ingestion service 106 may be fraudulent (e.g., correspond to a fake account. Receiving user feedback denying access to the particular third party data ingestion service 106 may thereby improve quality of the domain persona at least by excluding data that may be fraudulent.

The user may, in some examples, allow access to a subset of data corresponding to a user included in a third party data ingestion service 106, such as by excluding certain data types. The ability to allow access to a subset rather the whole of the data may improve user comfort with use of the domain persona system 114 by allowing the user transparency and control over the data the domain persona system 114 incorporates into a domain persona or personas for the user. User feedback to access a subset of data may also improve the quality of generated domain personas. The third party data ingestion service 106 may, for example, segment their data by domain (e.g., travel, food, music, art, shopping, social media use, work, school, and the like, or some combination thereof) where data corresponding to each domain may be considered a type. Travel search data, for example, may be considered to be of a travel type. As one example, the user may allow the domain persona system 114 to access data types excluding work or school when generating a family travel domain persona for the user. The ability to exclude data types may thereby improve accuracy of the domain persona system 116.

The domain persona system 114 may, as will be described in more detail with respect to FIG. 8, solicit user feedback during generation of a domain persona, such as by providing feedback to add, remove, or edit information recommended for incorporation into a domain persona, such as first data accessed from a third party data ingestion service 106 and/or generated insights drawn from the first data insights based on the first data.

Incorporating user feedback may advantageously improve accuracy of the generated domain persona at least by leveraging user knowledge of their own behavior, preferences, perspectives, insights, or the like, with respect to a specified domain. Illustratively, when generating a domain persona for a particular user, the domain persona system 114 may generate insights for a user with respect to a domain based on raw data accessible to the domain persona system 114, where insights represent conclusions drawn regarding a user's behavior, preferences, perspectives, interests, and the like, or some combination thereof, with respect to a specified domain. As one example, when generating a travel domain persona for a user, the domain persona system 114 may draw the insight that a particular user has visited South Indian restaurants. The domain persona system 114 may draw a further insight that the user likes South Indian restaurants. However, the particular user may have knowledge that they only visit South Indian restaurants because friends, coworkers, and family members prefer them. The particular user may, for example, actually prefer North Indian restaurants. The particular user may edit the insight to reflect a preference for North Indian restaurants thereby improving the quality of the generated domain persona.

The feedback incorporation system 142 may store user feedback in the feedback database 132. The feedback incorporation system 142 may additionally, or alternatively, access the user's feedback in the feedback database 132 to generate an updated recommendation for incorporating the information into the domain persona. Incorporating user feedback will be described in more detail herein with respect to the feedback incorporation system 142 and with respect to FIGS. 4-9B.

### 2.1.3. Permissions Database

The permissions database 134 may store authorizations by one or more users. The authorizations may include, but are not limited to, authorizations to access data from one or more third party data ingestion services 106. The permission management system 119 may, for example, store authorizations to access specified types of data from one or more third party data ingestion services 106 in permissions database 134, as described with respect to the feedback database 132.

The permissions management system 119 may additionally, or alternatively, retrieve authorizations to access a third party data ingestion service 106. The domain persona system 114 may, for example, receive a request to update a domain persona for a specified user with respect to a specified domain with data from a specified third party data ingestion service 106. In further examples, the domain persona system 114 may have accessed the specified third party data ingestion service 106 at, or during, a prior time period in the past and stored the credentials authorizing access to the specified third party data ingestion service 106 in permissions database 134. The credentials may still be valid at the time of receipt of the request to update the domain persona. Accordingly, the permissions management system 119 may access the permissions database to retrieve the credentials automatically (e.g., at a collection interval configured by default or by the user) and/or via manual approval (e.g., user-initiated).

The collection interval for automatic collection may be hours, weeks, months, or the like. In some examples, the collection intervals may be adjusted based on various criteria, such as different domains having different needs, users generating more/less content resulting in varying collection times, and the like, or some combination thereof. Illustratively, a personal travel domain persona may require more frequent updates than a business travel domain persona. A user may, for example, change their behavior, preferences, perspectives, and insights with respect to personal travel fairly frequently based on social media influencers, recommendations from friends, changing preferences of other family members or friends, and the like, or some combination thereof. Illustratively, a user may, for example, not have an interest in a particular travel destination. However, the particular travel destination may begin trending (e.g., on social media), and the user may thus develop an interest in traveling to the destination based on review of media surrounding the particular travel destination. More frequent collection intervals could capture this change in interest with respect to the particular travel destination. However, since business travel may be more consistent, such as regular visits to client offices, factories, business partners, and the like, or some combination thereof, a longer collection interval may work for the business travel domain.

The domain persona system 114 may then access the specified third party data ingestion service 106 to obtain updated data for the specified user with respect to the specified domain. Additional examples on utilization of the permissions database 134 will be described in more detail with respect to the permission management system 119 herein.

### 2.2. Data Intake System

The data intake system 116, as illustrated in FIG. 2, includes a permission management system 119, identity resolution system 120, import adapter system 121, and domain relevance scoring system 122. The data intake system 116 may handle incoming data from multiple data sources, such as a plurality of third party data ingestion services 106 of FIG. 1.

Rules relating to intake may differ based on domain. Illustratively, collection intervals may vary based on domain, or based on the entity controlling the data source to be ingested as described with respect to permissions database 134.

### 2.2.1. Permission Management System

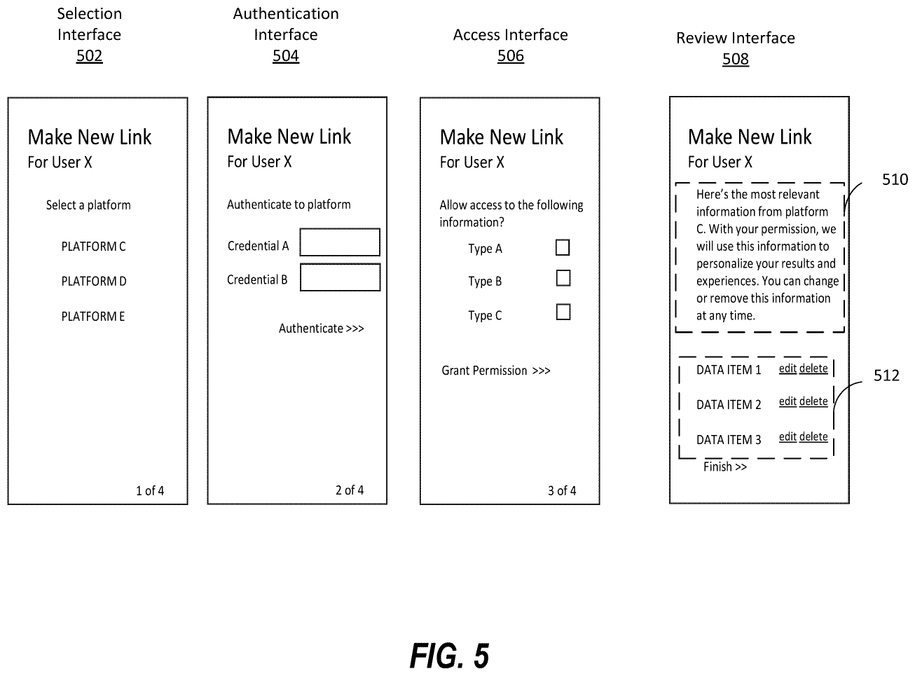

The permission management system 119 may confirm that the user authorizes the domain persona system 114 to access data from the third party data ingestion service 106 prior to downloading the data. The permission management system 119 may further store parameters including, but not limited to, specification of raw data to which the user has authorized access, a time period until the user should reauthorize access (e.g., download the data as often as configured for the time period before requiring reauthentication, where the time period can be 1 hour, 1 day, 1 week, 6 months, 1 year, or the like), a number of uses/downloads of the authorized user data (e.g., download the data 1, 10, 100 times before requiring reauthentication), and the like, or some combination thereof. For example, the permission management system 119 may store the parameters in permissions database 134 of storage system 126. The permission management system 119 may also facilitate the deletion of data corresponding to a user (e.g., if requested by the user). Handling of permissions during data intake will be described further in FIGS. 4-5.

### 2.2.2. Import Adapter System

For each third party data ingestion service 106, the data intake system 116 may include an import adapter implemented by import adapter system 121. With continued reference to the illustrative example, the import adapter system 121 may convert data imported from the third party data ingestion service 106 into a common format for continued processing by the data intake system 116. The domain relevance scoring system 122 may then score the raw data for relevance. Once authorization is received, the data intake system 116 may receive or obtain the raw data to which the user has authorized access (e.g., via the permission management system 119.)

### 2.2.3. Identity Resolution System

On receipt of raw data from a third party data ingestion service 106 (e.g., via an import adapter of import adapter system 121), the identity resolution system 120 may then verify that the raw data is above or below a threshold level for fraud, where fraud may indicate that an account corresponding to the raw data (e.g., with a third party data ingestion service 106) corresponds to a fake user rather than a genuine user. To determine whether the raw data is above or below a threshold level of fraud, the identity resolution system 120 may employ a fraud detection service, as described below with respect to fraud detection service 123.

### 2.2.3.1. Fraud Detection Service

The identity resolution system 120 may, in some examples, employ a fraud detection service, internal or external to the domain persona system 114, to verify that the raw data corresponds to a genuine user. The identity resolution system 120 may, for example, call fraud detection service 123. Fraud detection service 123 may determine a likelihood of fraud by checking the age of items within the raw data, checking that the number of data items in the raw data is above a threshold, and the like, or some combination thereof. If the likelihood of fraud for a data item, or a set of data items, is above a specified threshold, the domain persona system 114 may not download the data item.

Illustratively, raw data of a third party data ingestion service for a specified user may share the same age. Sharing an age may indicate that the data items were created at the same time, which may increase the likelihood that the raw data is fraudulent (e.g., corresponds to a fake account). As another example, raw data of a third party data ingestion service for a specified user may include few data items. Few data items may additionally, or alternatively, increase the likelihood that the raw data is fraudulent. The fraud detection service 123 may determine a fraud score for each data item included in the raw data, a fraud score for subsets of the raw data (e.g., subsets associated with distinct accounts), and the like, or some combination thereof.

Fraud detection service 123 may, in some examples, employ machine learning (ML) algorithms to assess a likelihood of fraud corresponding to data item. The term “model” or “ML model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, ML models, multimodal models (e.g., models or combinations of models that can accept inputs of multiple modalities, such as images and text), and/or the like. The fraud detection service 123 may illustratively use a machine learning algorithm to determine a likelihood of fraud for data of a third party data ingestion service 106 that corresponds to a specified user, such as a likelihood of fraud for each data item corresponding to the user, for groups of data items corresponding to a specified user (e.g. all data items for an account of the specified user), and the like, or some combination thereof.

Identity resolution and fraud detection will be described further in FIG. 4.

### 2.2.4. Domain Relevance Scoring System

The domain relevance scoring system 122 may identify a relevant subset of data, such as from one or more third party data ingestion services 106. The domain relevance scoring system 122 may, for example, determine a score for each data item in raw data from at least one third party data ingestion service 106. Relevance may be determined prior to, or subsequent to, downloading data from a third party data ingestion service 106 for further processing (e.g., to generate a domain persona for a specified user with respect to a specified domain). For example, the data intake system 116 may employ the domain relevance scoring system 122 to determine a relevant subset of data with respect to a specified user and a specified domain prior to downloading the data for further processing. The data intake system 116 may alternatively, download data from a third party data ingestion service 106 corresponding to a user with respect to a specified domain and then employ the domain relevance scoring system 122 to determine a relevant subset of data with respect to a specified user and a specified domain.

The domain relevance scoring system 122 may, in some examples, summarize results of relevance scoring and provide the results to the user. For example, the domain relevance scoring system 122 may leverage the display system 144 to generate an interface including results of relevance scoring for data items of a third party data ingestion service 106.

The domain relevance scoring system 122 may, in some examples, employ a relevancy service (internal or external to the domain persona system 114) to identify a relevant subset of data from a third party data ingestion service 106. The domain relevance scoring system 122 may, in some examples, employ relevancy service 124.

### 2.2.4.1. Relevancy Service

The relevancy service 124 may determine a relevance score with respect to a specified domain for individual data items, groups of data items (e.g., corresponding to a user account), etc. The relevancy service 124 may, for example, receive a set of data items from the relevance scoring system 122. The data items may correspond to a specified user and at least one of a third party data ingestion service 106 or a co-owned entity. The relevancy service 124 may also receive identification of a specified domain.

The relevancy service 124 may, in some examples, include tools, such as scoring rules, ML models, and the like, or some combination thereof, for each domain. The relevancy service 124 may, for example, apply rules in generating a score for individual data items, groups of data items (e.g., corresponding to a user account), and the like, or some combination thereof. Illustratively, the relevancy service may include a rule that visits to museums are highly relevant to the travel domain. The relevancy service 124 may accordingly apply the rule to score data items relating to museum visits as highly relevant.

The relevancy service 124 may, in some examples, employ machine learning models trained to identify relevance in each domain, such as classification algorithms, LLMs, and the like, or some combination thereof. As used herein, a Language Model is any algorithm, rule, model, and/or other programmatic instructions that can predict the probability of a sequence of words. An LLM is any type of language model that has been trained on a larger data set and has a larger number of training parameters compared to a regular language model.

Determining relevance for raw data received from third party data ingestion services 106 will be described in more detail with respect to FIGS. 4-7B. Intake of raw data and subsequent relevance scoring will be described in more detail in FIGS. 4-7B.

### 2.3. Data Fusion System

The data fusion system 136 may handle incorporation of raw data determined to be relevant to a particular domain and a particular user into a domain persona for the particular user. As illustrated in FIG. 2, the data fusion system 136 includes user insight system 138.

### 2.3.1. User Insight System

The user insight system 138 may handle communication with a user during generation of a domain persona, such as after data has been accessed by the data intake system 116. Illustratively, the data fusion system 136 may generate insights (e.g., with respect to a specified domain) and/or a recommendation to incorporate information or insights, such as data or insights determined based on data accessed from a third party data ingestion service 106, and the like, or some combination thereof. The user insight system 138 may generate a human readable explanation of the recommendation or insight, such as by using a machine learning model (e.g., a large language model (LLM)). The user insight system 138 may additionally, or alternatively, generate a human readable explanation of the information. The data fusion system 136 may then present the generated human readable explanation or explanations to the user in addition to a request for feedback. The data fusion system 136 may, for example, provide the generated human readable explanation or explanations to the display system 144, which may generate an interface including the generated human-readable explanation or explanations and request for feedback.

Interfaces for receipt of human feedback will be described in more detail herein, with respect to FIGS. 4-9B. The user insight system 138 further includes explanation generation system 140 and feedback incorporation system 142, which may be leveraged during communication with the user in generation or updates to the domain persona, such as in the above example.

### 2.3.1.1. Explanation Generation System

The explanation generation system 140 may generate human-readable explanations of relevance scoring determinations, recommended plans (also referred to herein as “recommended merge paths”) to incorporate data determined to be relevant, and the like, or some combination thereof. The explanation generation system 140 may, for example, include one or more large language models (LLMs).

With continued reference to the illustrative example, the user insight system 138 may generate a human readable explanation of the recommended merge path with the explanation generation system 140. The user insight system 138 may, for example, call the explanation generation system 140 on receipt of a recommendation from another component of the data fusion system 136, such as from the feedback incorporation system 142. The explanation generation system 140 may then generate a human readable explanation to incorporate information, such as data from a third party data ingestion service 106, generated insights derived from the data with respect to a specified domain, and the like, or some combination thereof, into the domain persona. The explanation generation system 140 may additionally, or alternatively, generate a human readable explanation of the information. Interfaces for receipt of human feedback will be described in more detail herein, with respect to FIGS. 4-9B.

### 2.3.1.2. Feedback Incorporation System

Feedback incorporation system 142 may generate a recommended method to incorporate information corresponding to a user, such as: data from a third party data ingestion service 106, generated insights derived from the data with respect to a specified domain, and the like, or some combination thereof, into a domain persona. The recommended method to incorporate information into a domain persona may also be referred to herein as a recommended “merge path,” since third party data may be merged with previously accessed third party data (e.g., from the same or different third part(ies), internal data, and/or other third party data. The feedback incorporation system 142 may, in some examples, include tools and logic to identify similarities between raw data, such as from a third party data ingestion service 106, and an existing domain persona. These may include, but are not limited to, tools to calculate distances between vectors in an embedding space, LLMs, and the like, or some combination thereof. Embedding spaces, as used herein, are n-dimensional coordinate spaces that enable specification of machine-readable representations (embeddings) as vectors, where each vector represents something (e.g., an idea, an emotion, an object, etc.) in the real world. Each point (e.g., represented by a vector) within the embedding space has an n-dimensional location with n-dimensional coordinates where a distance between a set of two points or vectors signifies a relationship between the two points.

If the feedback incorporation system 142 identifies discrepancies between information (e.g., data from a third party data ingestion service 106, generated insights from the data, etc.) and a domain persona, for example, the feedback incorporation system 142, may generate a recommended merge path to resolve the discrepancy, as will be described in more detail herein with respect to FIG. 8.

As another example, if the feedback incorporation system 142 identifies that information (e.g., data from a third party data ingestion service 106, generated insights from the data, etc.) are absent in a domain persona, the feedback incorporation system 142, may generate a recommended merge path to add the absent information, as will be described in more detail herein with respect to FIG. 8.

As yet another example, if the feedback incorporation system 142 identifies that there are discrepancies within the information (e.g., data from a third party data ingestion service 106, generated insights from the data, etc.), the feedback incorporation system 142, may generate a recommended merge path to resolve the discrepancy.

The feedback incorporation system 142 may also update the merge path responsive to user feedback. Generation of updated and recommended merge paths will be described in more detail with respect to FIG. 8.

In some examples, the feedback incorporation system 142 may merge the information with a domain persona in accordance with a recommended merge path or updated merge path. Illustratively, and for example, the feedback incorporation system 142 may modify a specified domain persona in accordance with the recommended or updated merge path by providing instructions to the multi-party domain persona database 130.

### 2.4. Display System

The display system 144 may generate user interfaces including human readable explanation(s) (e.g., of data from a third party data ingestion service 106, generated insights from the data, etc.) Illustratively, the display system 144 may receive instructions from the permissions management system 119 including specification of an authorization required from a user from a particular third party data ingestion service 106. The display system 144 may accordingly generate an interface including the request for authorization including specification of the particular third party data ingestion service 106. The domain persona system 114 (e.g., via the feedback incorporation system 142) may provide the generated interface to the user (e.g., through a user device 102).

As another example, the explanation generation system 140 may generate a human-readable explanation(s) (e.g., of data from a third party data ingestion service 106, generated insights from the data, etc.). The explanation generation system 140 may send instructions to the display system 144 to generate an interface including the human readable explanation(s). The explanation generation system 140 may, in some examples, also include instructions to allow the user to add, modify, or remove explanation(s) in the interface. The display system 144 may accordingly generate an interface in accordance with the instructions. The domain persona system 114 (e.g., via the feedback incorporation system 142) may then provide the generated interface to the user (e.g., through a user device 102).

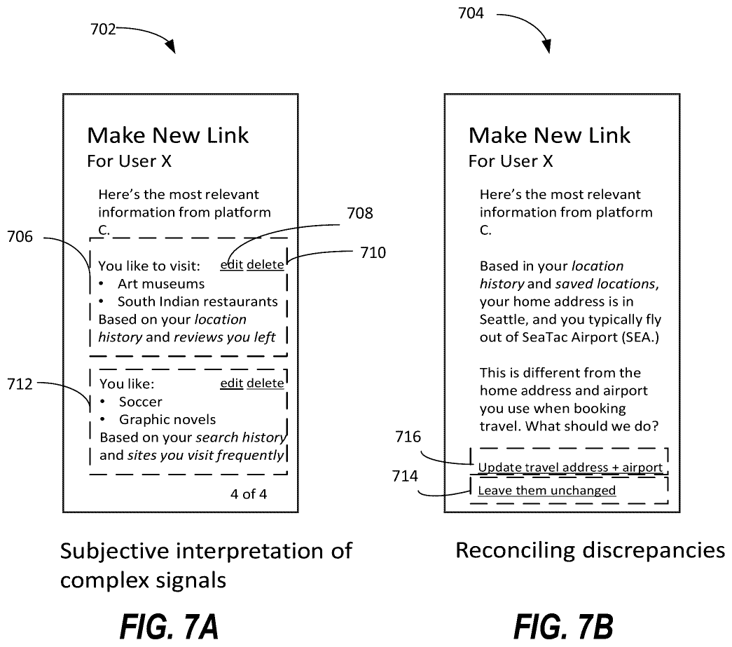

Interactions with a user (e.g., through a user device 102 of FIG. 1) in determining relevance and generating or updating a domain persona will also be described in more detail in FIGS. 7B-9B.

### 2.5. Implementation System

Implementation system 146 may utilize generated domain personas in downstream machine learning applications, such as travel applications, as will be described in FIGS. 10-11 herein. Implementation system 146 may incorporate any of the features related to any of the systems and methods described and/or illustrated in U.S. Patent Application No. 63/640,752, titled “Progressive Travel Intelligence System,” which is incorporated by reference herein in its entirety.

### 2.6. Export System

Export system 148 may facilitate export of generated domain personas to requestors (e.g., entities who previously requested domain personas), such as third party systems (e.g., third party systems 118 of FIG. 1), co-owned entities, and the like, or some combination thereof. The export system 148 may, for example, export domain personas in a single format (e.g., a JavaScript Object Notation (JSON) data structure, comma separated value (CSV), etc.). A requestor may subsequently convert the exported domain persona into a different data format for use in downstream machine learning applications.

The export system 148 may alternatively export the domain personas in specific formats for requestors. For example, the export system 148 may use export adapters implemented by export adapter system 150. Each export adapter may be specific to a third party system 118 or co-owned entity. For example, to export a domain persona to a particular third party system 118, the export system 148 may output a domain persona in a format specific to the particular third party system 118, such as a format requested by the third party system 118. The particular third party system 118 may, for example, request that the domain persona be exported as a JSON data structure. The export adapter for the particular third-party system 118 may accordingly output the domain persona as a JSON data structure.

### 3. Example Domain Persona Data Structure

FIG. 3 is an illustrative diagram representing first user persona data 300 including subsets of data from one or more third party data sources, according to various aspects of the present disclosure. First user persona data 300 may be a visual representation of data included in a domain persona for a first user (first user for brevity)), where the domain persona is a representation of the specified user's behavior in a particular domain (e.g., travel, work-related research; household goods shopping, etc.). First user persona data 300 may be stored as structured data, unstructured data, or some combination thereof. As discussed with respect to the multi-party domain persona database 130 of FIG. 2, first user persona data 300 may be stored in a variety of structures including, but not limited to, a SQL table, a NoSQL data structure (e.g., a JSON database, MessagePack, etc.).

First user persona data 300 may, in some examples, represent a specified user's behavior in more than one domain. Illustratively, a travel domain persona may encompass multiple sub-domains, such as business travel, leisure travel, and the like. Each of these sub-domains may be represented in first user persona data 300. In some examples, each sub domain may correspond to separate layers of data, where each layer may be used separately in downstream machine learning applications leveraging the domain persona corresponding to first party user data 300. As one example, a travel domain persona for a specified user may include a business travel layer and a leisure travel layer. Each layer may be used separately by a downstream machine learning application for a travel search platform to customize the specified user's experience on the platform, such as by providing different user interfaces, different ads, different recommendations, and the like, or some combination thereof.

First user persona data 300 includes domain specific first party data 302. This may include an existing representation of the user corresponding to the first party identity. For example, the first party may be a co-owned entity, as described with respect to FIG. 2. For example, the first party may share an administrator with the domain persona system 114. The first party may have existing data sources including information relating to the specified user. For example, the first party may have websites on which user behavior is tracked with respect to a domain and store this data. By way of illustration, the first party may own travel related websites and store data (e.g., clickstream data, bookings, etc.) with respect to individual users.

Existing first party data for a first user may be evaluated for relevance with respect to the domain and the first user and incorporated into the first user persona data, which may form data for a domain persona for the first user. First user persona data 300 may additionally incorporate raw data from different third parties, such as third party data ingestion services 106 of FIG. 1. First user persona data 300 may additionally, or alternatively, store generated insights based on raw data from different third parties with respect to a particular domain made by the domain persona system 114, as discussed with respect to FIG. 2 and as will be described with respect to FIGS. 4-9B. First user persona data 300 may additionally, or alternatively, store insights generated based on the generated insights created by the domain persona system 114, as discussed with respect to FIG. 2 and as will be described with respect to FIGS. 4-9B.

FIG. 3 further illustrates that first user persona data 300 includes Party ‘A’ data 308 and Party ‘B’ data 310. Party ‘A’ data 308 may represent data for the first user collected by third party ‘A’ and/or generated insights based on the Party ‘A’ data 308. Party ‘A’ data 310 may be collected by a third party system 118 of FIG. 1. Party ‘B’ data 310 may represent data for the first user collected by a third party ‘B,’ and/or generated insights based on the Party ‘B’ data 310. Party ‘B’ data 310 may be collected by a third party system 118 of FIG. 1.

Prior to incorporation into the first user persona data 300, the data for each third party may also be evaluated for relevance with respect to the domain and the first user. Evaluation for relevance and incorporation of data determined to be relevant will be described in more detail with respect for FIGS. 4-7B. Based on the evaluation, some, or all of the data from the third parties may be incorporated into the first user persona data 300. As illustrated in FIG. 3, a subset 304 of third party data ‘A’ 308 may be determined to be relevant and be incorporated in the first user persona data 300. A subset 306 of third party data ‘B’ 310 may be determined to be relevant and be incorporated in the first user identity data 300. Determination of relevance and incorporation of the data determined to be relevant into first user persona data 300 will be described in more detail in FIGS. 4-7B.

### 4. Example Methods

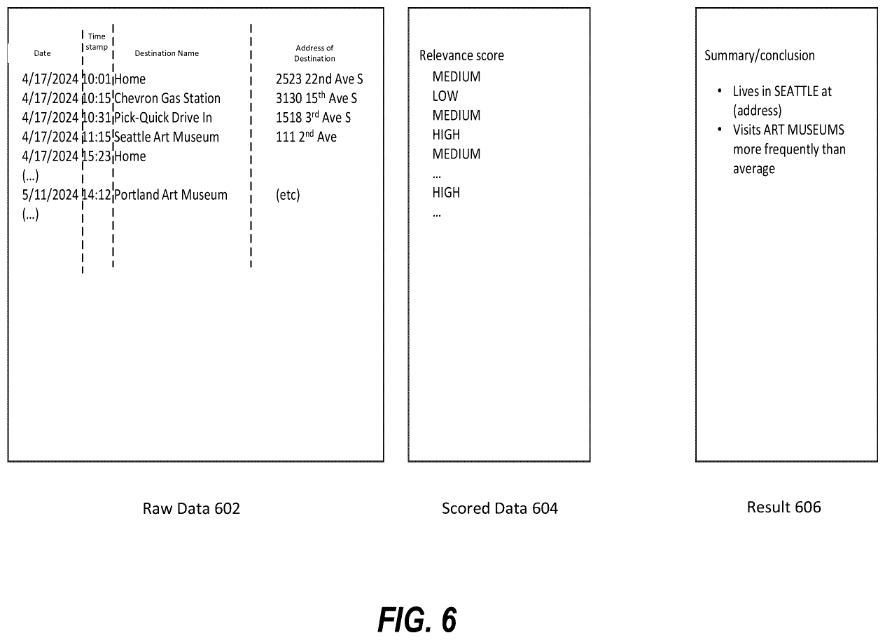

FIG. 4 is a flow diagram illustrating a method 400 to intake raw data from a third party data ingestion service 106 to the domain persona system 114, according to various aspects of the present disclosure. FIG. 5 depicts example interfaces for requesting intake of data from one or more specified third party data ingestion services, according to various aspects of the present disclosure. FIG. 6 depicts example interfaces for receipt and processing of data from one or more third party data ingestion services, according to various aspects of the present disclosure, and FIGS. 7A-7B depict example interfaces for generating insights with respect to data from one or more third party data ingestion services, according to various aspects of the present disclosure. FIGS. 5, 6, and 7A-7B will be described in conjunction with FIG. 4 at least because the interfaces illustrated in FIGS. 5, 6, and 7A-7B may be presented to a specified user during execution of method 400.

### 4.1. Data Intake Single Request

Some of the processes, steps, and/or modules discussed herein with respect to FIG. 4 may be combined, separated into sub-parts, omitted entirely, and/or rearranged to run in a different order and/or in parallel. In addition, in some examples, different blocks may execute on various components of a domain persona system, such as domain persona system 114 of FIGS. 1-2. By way of illustration, the method 400 may be implemented by a data intake system (e.g., data intake system 116 of FIG. 2). Data intake may be automatic or on request (e.g., from specified user, from a third party system 118, by a co-owned entity, etc.)

At block 402, the data intake system 116 may determine a list of third party data ingestion services, such as one or more third party data ingestion services (e.g., third party data ingestion services 106). As discussed with respect to FIG. 1, the list of third party data ingestion services 106 may include, but are not limited to, data portability APIs 108, message parsing systems 110, and data provider services 112. The list may include, in some examples, third party data ingestion services 106 for which the import adapter system 121 of data intake system 116 has existing import adapters to facilitate the intake of raw data. In some examples, the data intake system 116 may additionally, or alternatively, generate a list including a co-owned entity or entities. In some examples, the co-owned entities may correspond to existing import adapter(s) of import adapter system 121. As another example, co-owned entities may not require an import adapter. Instead, the co-owned entit(ies) may provide data by default in a format acceptable to the domain persona system 114.

At block 404, the domain persona system 114 may receive a request to generate or to update a domain persona. The domain persona system 114 may handle the request with a data intake system (e.g., data intake system 116 of FIG. 2). The request may include identification of a domain and of a specified user. The requestor may be, for example, a third party system (e.g., third party system 118 of FIG. 1), a co-owned entity, and the like, or some combination thereof. The request may include identification of a specified domain (e.g., travel, food, music, art, shopping, social media use, work, school, and the like, or some combination thereof), a specified user, and a specified third party data ingestion service or services (e.g., a third party data ingestion service 106 of FIG. 1). In some examples, the request may include a specified output format, data location, and the like, or some combination thereof. The request may further include instructions to link, and provide access to, a particular third party data ingestion service 106 or co-owned entity.

In some examples, the request of block 404 (to generate or update a domain persona) may include permission (e.g., credentials, authorizations, etc.) to access third party data ingestion services 106 or co-owned entities. The request of block 402 may be received, for example, through the user interfaces of FIG. 5. For example, a user (e.g., through a user device 102) may select a platform on selection interface 502, such as ‘Platform C.’ After selection of the platform, the user may provide authentication details through authentication interface 504. The permission management system 119 may store the provided authentication details in the permissions database 134, as discussed with respect to FIG. 2.

The user may additionally, or alternatively, grant permission to access selected data of the third party data ingestion service 106. Illustratively, the third party data ingestion service 106 may segment its data into a plurality of types, such as travel related searches, work research searches, and general shopping related searches. The user may therefore, in some examples, limit the domain persona system 114 to access specific data types. If the user is requesting to link the third party data ingestion service in order to generate or update a travel domain persona, for example, the user may limit the domain persona system 114 to accessing travel-related searches.

Returning to FIG. 5, to facilitate user granting or withholding access to data types of the particular third party data ingestion service 106, the user may select particular data types. The user may, for example, select the checkbox beside Type A, Type B or Type C on access interface 506 to allow the data intake system 116 access to the specified data types. The permission management system 119 of the data intake system 116 may then store the information on data types to which the data intake system 116 may access for the particular third party data ingestion service 106.

At block 405, the data intake system 116 may utilize the identity resolution system 120 to, for example, determine that no fraud has been detected with respect to data responsive to the request of block 404. By way of illustration, the specified user of the request received at block 404 may have an account with the particular third party data ingestion service 106. The identity resolution system 120, assuming access was authorized, and a connection was successful, may then analyze the accessed data items associated with the account of the specified user to determine that no fraud has been detected. As discussed with respect to FIG. 2, the identity resolution system 120 may analyze the data items with respect to the comparative ages of the data items, the number of data items with respect to one or more thresholds, and the like, or some combination thereof.

Additionally, as discussed with respect to FIG. 2, the identity resolution system 120 may call a fraud detection service (e.g., fraud detection service 123 of FIG. 2) to assess a likelihood of fraud with respect to the data accessed from the third party data ingestion service 106 or co-owned entity. As a reminder, the fraud detection service 123 may assess a likelihood of fraud with respect to a request received at block 404. Illustratively, a first request may specify a first user and a first domain. The request may further specify to access data from a first ingestion service (e.g., a third party data ingestion service 106, a co-owned entity, etc.). The data intake system 116 may identify data within the first ingestion service responsive to the first request, as described with respect to block 404. Fraud detection service 123 (e.g., after being called by identity resolution system 120) may analyze the identified data, using any of the methods discussed with respect to FIG. 2. Illustratively, the fraud detection service 123 may include rules specifying one or more thresholds with respect to characteristics of the identified (e.g., age of data, amount of data, etc.). The fraud detection service 123 may compare the amount of data items in the identified data, for example, to an amount of data items in a specified threshold. Based on this comparison, the fraud detection service 123 may determine a likelihood of fraud with respect to the first request.

At block 406, the data intake system 116 may determine whether a domain persona already exists for the specified user. Illustratively, the data intake system may query the multi-party domain persona database 130 to determine whether a domain persona is present for the specified user. The specified user may, in some examples, correspond to a number of domain personas for distinct domains (e.g., travel, work, shopping, etc.). Accordingly, the data intake system 116 may alternatively query the multi-party domain persona database 130 to determine whether a domain persona is present for the specified user for the domain identified in block 404.

If a domain persona corresponding to the request is not present, such as a domain persona associated with the specified user, the data intake system 116 may proceed to block 407 to generate an initial domain persona for the specified user. Illustratively, the data intake system 116 may allocate a space in memory within multi-party domain persona database 130 to hold data corresponding to a domain persona for the specified user for the domain identified in the request received at block 404. The initial domain persona may additionally, or alternatively, include data from a co-owned entity (e.g., domain specific first party data 302 of FIG. 3. Incorporating data into this initial domain persona corresponding to the allocated space in memory will be described further herein and with respect to FIGS. 5-9B.

If a domain persona corresponding to the request is present, such as a domain persona associated with the specified user, the data intake system 116 may proceed to block 408 to access the domain persona.

Subsequent to blocks 407 or 408, the data intake system 116 may proceed to block 410. At block 410, the data intake system 116 may determine that the particular third party data ingestion service 106 includes raw data corresponding to the identity of the specified user. The data intake system 116 may, for example, access the particular third party data ingestion service 106 with the credentials provided at block 404 and determine that the third party data ingestion service 106 has data to which the request at block 404 provided access. Additionally, or alternatively, the data intake system 116 may query the third party data ingestion service 106 and determine that the third party data ingestion service 106 has data to which the request at block 404 provided access.

At block 412, the data intake system 116 may access raw data relating to the specified service from the particular third party data ingestion service. The data intake system 116 may, for example, obtain the data identified at block 410. The data intake system 116 may additionally, or alternatively, obtain a subset of the data identified at block 410.

At block 414, the data intake system 116 may identify a subset of data within the raw data that is relevant to the domain for the domain persona. By way of illustration, the import adapter system 121 of the data intake system 116 may have an import adapter specific to the third party data ingestion service 106, import adapters specific to the domain, or some combination thereof. These import adapters may be used in identification of a subset of data relevant to the domain from the raw data of the third party data ingestion service 106.

With reference to FIG. 6, the raw data 602 may be from a particular third party data ingestion service 106. Raw data, for example, could be in the form of a table with headings, including date, timestamp, destination name, and address of destination, for example raw data 602 of FIG. 6. As other examples, raw data may be in data structures including, but not limited to, arrays, linked lists, trees, graphs, the like, or some combination thereof.

The import adapter system 121, as discussed with respect to FIG. 2, may include an import adapter for the particular third party data ingestion service 106. The import adapter for the particular third party data ingestion service 106 may parse raw data 602 from the particular third party data ingestion service 106 to extract relevant information for a specific domain from the raw data. For a travel domain example, destination names may be considered relevant. Accordingly, to generate a travel domain persona for a user corresponding to raw data 602, an import adapter for the particular third party data ingestion service 106 may extract the third column of raw data 602 that relates to the destination name.

The data intake system 116 may additionally, or alternatively, score the raw data for relevance with respect to a particular domain. For example, as discussed with respect to FIG. 2, the data intake system 116 may include domain relevance scoring system 122. The domain relevance scoring system 122 may include a variety of tools, including machine learning (ML) models trained to determine relevance with respect to particular domains, scoring rules, and the like, or some combination thereof. With continued reference to FIG. 6, the domain relevance scoring system 122 may score each data item for relevance with respect to the domain. As illustrated in scored data 604, the scoring may assign each data item a score of low, medium, or high.

At block 416, the data intake system 116 may generate insights with respect to the subset. With continued reference to the illustrative example of FIG. 6, the relevance scoring system 122 may note that visits to art museums are of high relevance. As another example, the relevance scoring system 122 may note that visits to home or drive-ins are of medium relevance.

In some examples, the data intake system 116 may generate further insights based on initial insights. With continued reference to the illustrative example of FIG. 6, based on the data intake system 116 determining that visits to art museums are of high relevance, and the number of visits that the user has made to art museums, the data intake system 116 may accordingly generate the insight that the specified user “Visits ART MUSEUMS more frequently than average” in results 606. As another example, based on the data intake system 116 determining that visits to home or drive-ins are of medium relevance, the data intake system 116 may generate the insight that the specified user “Lives in Seattle . . . ”

In some examples, the data intake system 116 may solicit user input to confirm the insights. With reference to FIG. 5, the data intake system may present review interface 508 including the insight 510 and selectable options 512 to edit or delete data items corresponding to the insight, such as data items from which the insight 510 was derived. As another example, with reference to FIG. 7A, the data intake system 116 may provide the insights to the users through interface 702, which may be presented on a user device 102 of FIG. 1. Illustratively, the user may provide insight 706 that the user enjoys visiting “art museums” and “South Indian restaurants.” The interface 702 includes edit link 708 and delete link 710, which the user may select to edit the insight or delete the insight. Deletion of the insight may prevent the insight from being provided to a data fusion system at block 420.

At block 420, the data intake system 116 may provide the insights and/or portions of the subset of data identified to a data fusion system, such as data fusion system 136 of FIG. 1, as will be described in more detail with respect to FIG. 8.

A user may, for example, provide feedback on generated insights (e.g., through an interface). With reference to FIG. 7A, the data fusion system 136 may receive feedback to edit generated insight 706 through edit link 708. Illustratively, the user that may edit the insight that they enjoy visiting “South Indian restaurants” to instead indicate that they enjoy visiting North Indian restaurants. The feedback incorporation system 136 may update the insight 706 to include that the enjoy visiting North Indian restaurants.

In some examples, a user may provide feedback that the insight 706 is correct. Illustratively, a user may not select edit link 708 or delete link 710. The data fusion system 136 may interpret this lack of feedback as confirmation that insight 706 is correct. As another example, the interface 702 may include a confirm link for each insight, a submit button, and the like, or some combination thereof, which may be selected by the user to indicate that an insight or insights is correct.

### 4.2. Data Intake—Multiple Requests

In some examples, the domain persona system 114 may receive multiple requests to generate or update a domain persona from different requestors. The requests may, in some examples, share instructions, such as to link, and provide access to, a specified third party system 106 and access data for a specified user. The domain persona system 114 (e.g., with the data intake system 116) may consolidate requests with shared instructions. Illustratively, a first request and a second request may be received within a first time period (e.g., a specified or default number of seconds, minutes, hours, days, etc.). The first and second request may share instructions to link, and provide access to, a specified third party system 106 and access data for a specified user.

In further examples, the data intake system 116 may consolidate these instructions, such as by performing conducting blocks 410 and 412 together for the first and second request. Illustratively one operation to download data for the specified user from the third party data ingestion service 106. The data intake system 116 may then process the downloaded data for each of the first and second request in accordance with the method 400 specified in blocks 404-420 below. This may advantageously save computing resources in conducting the download operation.

In some examples, the first request may specify a first domain, while the second request specifies a second domain. The data intake system 116 may still perform one operation to download data for the specified user from the third party data ingestion service 106. The data intake system 116 may then process the downloaded data for each of the first and second request in accordance with the method 400 specified in blocks 414-420. As another example, the data intake system 116 may perform separate download operations for each of the first and second requests at blocks 410 and 412. The download operations may download the same data, such as data of the third party data ingestion service 106 that corresponds to the specified user.

Alternatively, the data intake system 116 may first identify a subset of data within the raw data of the third party data ingestion service corresponding to the specified user that is relevant with respect to the identified domain, as will be described with respect to block 414. For example, for the first request, the data intake system 116 may identify a subset of data within the raw data of the third party data ingestion service corresponding to the specified user that is relevant with respect to the first domain, using any of the methods described at block 414. The data intake system 116 may then download the identified subset. The data intake system 116 may then further process the data as will be described with respect to blocks 416 and 420.

As yet another example, the data intake system 116 may identify a first subset of data relevant to the first domain, such as by identifying data types in the raw data of the third party data ingestion service 106 that are relevant to the first domain. The data intake system 116 may download this subset at blocks 410 and 412. The data intake system 116 may then conduct additional analysis on the first subset of data at block 414 to identify a second subset of data relevant to the first domain.

As an additional example, the data intake system 116 may access the third party data ingestion service 106 and request data corresponding to the specified user. The data intake system 116 may additionally, in some examples, request data for the specified user corresponding to the identified domain. For example, the third party data ingestion service 106 may include segmented data such as data segmented into travel-related searches, work-related searches, general shopping related searches, and the like, or some combination thereof.

While the description herein indicates that the method 400 is being implemented by the data intake system 116, for example. Different blocks may execute on various components of a domain persona system 114. By way of illustration, block 416 may be implemented with a data fusion system, such as data fusion system 136 of FIG. 1, as will be described in more detail with respect to FIG. 8.

### 4.3. Data Fusion

FIG. 8 is a flow diagram illustrating a method 800 to merge data from third party data ingestion services (e.g., third party data ingestion services 106 of FIG. 1) with a first domain persona representing a first user with respect to a specified domain, according to various aspects of the present disclosure. FIGS. 7A-7B, as mentioned herein, depict example interfaces for generating insights with respect to data from one or more third party data ingestion services, according to various aspects of the present disclosure. FIGS. 9A-9B depict example interfaces for viewing and editing data included in a domain persona. FIGS. 7A-7B and 9A-9B will be described in conjunction with FIG. 8 at least because the interfaces illustrated in FIGS. 7A-7B and 9A-9B may be presented to a first user during execution of method 800. The method 800 may be used when generating a domain persona or when updating a domain persona, as will be described in more detail in blocks 804-816 herein.

Some of the processes, steps, and/or modules discussed herein with respect to FIG. 8 may be combined, separated into sub-parts, omitted entirely, and/or rearranged to run in a different order and/or in parallel. In addition, in some examples, different blocks may execute on various components of a domain persona system, such as domain persona system 114 of FIGS. 1-2. By way of illustration, the method 800 may be implemented by data fusion system 136 of FIG. 2.

At block 802, the data fusion system 136 may receive input from a data intake system, such as data intake system 116 of FIG. 2. Illustratively, the data fusion system 136 may receive generated insights, and/or a subset of data within the raw data as discussed with respect to FIG. 4.

For example, the data fusion system 136 may receive a subset of raw data identified as relevant to the domain for the first domain persona, such as described with respect to FIG. 4 at block 414. The data fusion system 136 may process the received data of raw data with the user insight system 138, as discussed with respect to FIG. 2. The user insight system 138 may generate insights with respect to the received data using any of the methods described with respect to block 416 of FIG. 4. The user insights system 138 may, for example, generate insights with the explanation generation system 140, as discussed with respect to FIG. 2. The user insight system 138 may additionally, or alternatively, generate insights using any of the methods described with respect to block 416 of FIG. 4. The user insights system 138 may, for example, generate the insights with the explanation generation system 140, as discussed with respect to FIG. 2. The data fusion system 136 may then use the generated insights, and/or the received data to generate a recommended merge path, as will be described at block 804.

As another example, the data fusion system 136 may receive generated insights as input from the data intake system 116. The user insight system 138 may generate insights using any of the methods described with respect to block 416 of FIG. 4. The user insights system 138 may, for example, generate the insights with the explanation generation system 140, as discussed with respect to FIG. 2. The data fusion system 136 may then use the generated insights, and/or received data to generate a recommended merge path, as will be described at block 804.

At block 804, based on the received input from block 802, the data fusion system 136 may generate a recommended merge path that includes a method to incorporate information (e.g., the generated insights, and/or received data) that is determined to be relevant to the domain (e.g., see FIG. 2, FIG. 4 at block 420, block 802, etc.) into the first domain persona. The data fusion system 136 may, for example, identify options for incorporating the information into the first domain persona. The data fusion system 136 may, in some examples, use the feedback incorporation system 142 to generate the options. The data fusion system 136 may additionally, or alternatively, use the explanation generation system 140 to generate the options. The options may include, adding information to the first domain persona, excluding information from the first domain persona, and the like, or some combination thereof. The options may additionally, or alternatively, include a request for additional information from the first user corresponding to the first domain persona, such as with respect to the accuracy of the information.

As an example, and with respect to FIG. 7A, generated options to add information from the received input from block 802 for a travel domain persona may include that the first user, for example, enjoys or is interested in the following: visits to art museums, visits to south Indian restaurants, soccer, and graphic novels. With respect to FIG. 7B, options including a request for additional information from the first user may include request to resolve conflicts within the received input, to resolve conflicts between the received input from block 802 and information within the first domain persona, fix incorrect information within the first domain persona, add information to the first domain persona, confirm information within the first domain persona, and the like, or some combination thereof. Receipt of feedback from the first user will be described in more detail herein with respect to blocks 806-812.

To generate options for incorporating the information into the first domain persona, the data fusion system 136 may analyze what information is presently stored in the first domain persona for the first user. Illustratively, the data fusion system 136 may identify whether information within the received input (e.g., from block 802) matches or is similar to information that is already present in the first domain persona. To identify matching or similar information present in the first domain persona, the data fusion system 136 may use matching techniques including, but not limited to, exact matching, fuzzy matching, probabilistic matching, or artificial intelligence or machine learning based matching (e.g., decision trees, random forests, neural networks, etc.), and the like, or some combination thereof.

In some examples, the data fusion system 136, may not be able to identify matching or similar information within the domain. The first domain persona may, for example, be an initial domain persona for the first user, as discussed with respect to block 407 of FIG. 4. The initial domain persona may include information from the initial request to link a particular third party data ingestion service, as discussed with respect to block 404 of FIG. 4. The initial domain persona may additionally, or alternatively, include data from a co-owned entity (e.g., domain specific first party data of FIG. 3) Accordingly, the data fusion system 136 may not be able to identify matching or similar information between the received input and the information included in the first domain persona. The recommended merge path may thus include recommendations to incorporate all information in the received input.

Alternatively, the recommended merge path may recommend incorporation of only a subset of the received input. For example, the data fusion system 136 may include a machine learning model or machine learning models trained on historical data, where the historical data includes indications of improved performance of downstream machine learning applications based on the inclusion or exclusion of information from the first domain persona. The historical data may include an indication that incorporation of insights significantly improved results of downstream machine learning applications.

By way of illustration, the downstream machine learning application may facilitate travel recommendations, travel planning, and the like, or some combination thereof. Historical data from application of the downstream machine learning application to generate recommendations, facilitate travel planning, and the like, or some combination thereof, may indicate an improved likelihood of a booking when a specific data type incorporated in the first domain persona. Illustratively, the historical data may further indicate that including generated insights generally increased the number of bookings. However, incorporation of the received input of block 802 did not change or even reduced the number of bookings. Accordingly, the data fusion system 136 may generate a recommended merge path recommending incorporation of the insights into the first domain persona and exclusion of the received input from block 802, for example. As another example, the data fusion system 136 may generate a recommended merge path recommending information of a portion of the insights be incorporated into the first domain persona.

If matching or similar data is identified within the first domain persona, the data fusion system 136 may conduct further analysis to determine whether the information in the received input conflicts with the identified information in the first domain persona. If so, the data fusion system 136 may generate options including a request for information from the user on whether the information in the received input (e.g., from block 802) or the information in the first domain persona is correct.

With continued reference to FIG. 7B, the data fusion system 136 may generate options including a request for information including to resolve a conflict in the first user's home address with respect to generating or updating a travel domain persona. The options, as illustrated in interface 704 of FIG. 7B are to update a travel address or leave a travel address unchanged. The information in the domain identity may, for example, indicate that the user's home address is in Seattle based on “location history” and “saved locations.” The information in the received input may however indicate a different home address, such as an address in Portland, is used in booking travel. Accordingly, the data fusion system 136 may generate the options the request to resolve the conflict as illustrated in FIG. 7B using the explanation generation system 140.

While this example indicates a request for information to resolve a conflict between information in received input (e.g., from block 802) and information in the first domain persona, such as a travel domain persona, for example. The data fusion system 136 could, as another example, generate options including a request for information to resolve a conflict within different portions of the received input. With continued reference to FIG. 7B, for example, the received input could include location history information, saved locations, and travel booking information. The data fusion system 136 may thus identify a conflict within this received input and generate the options indicated in FIG. 7B.

In some examples, the data fusion system 136 may determine a confidence level with respect to data items of received input (e.g., from block 802) and generated insights. Confidence level(s) may be determined with methods including, but not limited to, application of rules, ML models, and the like, or some combination thereof. Confidence level(s) may, for example, indicate a probability that the received input (e.g., from block 802) and insights, and the like, or some combination thereof, accurately represents the behavior, preferences, perspectives, insights, and the like, of a user (e.g., the first user) with respect to a specified domain (e.g., travel, food, music, art, shopping, social media use, work, school, the like, or some combination thereof). The data fusion system 136 may, in further examples, apply one or more thresholds based on confidence level of data items of received input (e.g., from block 802) and generated insights to determine what information should be presented to the first user for review. The data fusion system 136 may, for example, apply a confidence interval defining a range of confidence levels. Illustratively, data items and/or insights with confidence levels outside the confidence interval may be presented to a user for confirmation, modification, addition of information, the like, or some combination thereof.

At block 806, the data fusion system 136 may request user feedback on the recommended merge path. The data fusion system 136 may utilize a display system (e.g., display system 144 of FIG. 2). In further examples, the data fusion system 136 may generate and transmit instructions to display system 144. The display system 144 may, based on the instructions generate an interface including the recommended merge path for presentation to the first user. The domain persona system 114 may then transmit the interface for display on a user device (e.g., a user device 102 of FIG. 1).

The data fusion system 136 may also utilize a feedback incorporation system (e.g., feedback incorporation system 142) to include requests for feedback with respect to the recommended merge path.

As an example, and with continued reference to FIG. 7A, to incorporate information such as insight 706 and insight 712 for each option, the first user may be provided with selectable components, such as edit link 708 and delete link 710. The first user may select these links to provide feedback. The first user may, for example, select edit link 708 and update the insight to indicate that the first user likes to visit North Indian restaurants instead of South Indian restaurants. As another example, the user may delete insight 706 to indicate that insight 706 should not be included in the travel domain persona for the first user.

As another example, with reference to FIG. 7B, the first user may indicate that the home address and airport used for booking travel are accurate by selecting selectable area 714 to leave the information in the travel domain persona unchanged, for example. The first user may alternatively select selectable area 716 to indicate that the home address and airport for the travel domain persona for the first user should be updated to the city of “Seattle” and “SEA” airport to match the home address and airport in the first user's location history and saved locations.

In some examples, the data fusion system 136 may solicit additional data from the user. The additional data may, for example, be data that is not present in the received input from block 802 or does not already exist in the first domain persona (e.g., domain specific first party data 302). In further examples, the data fusion system 136 may solicit the additional data based on the inclusion of similar data in downstream machine learning applications for a specified domain (e.g., travel, food, music, art, shopping, social media use, work, school, and the like, or some combination thereof). Illustratively, a travel recommendation and/or planning service may utilize travel domain personas for multiple users. Data derived from bookings made in the travel recommendation and/or planning service by the multiple users may indicate that inclusion of an insight with respect to an individual user's favorite color increased the likelihood that the individual user would book a travel item (e.g., a hotel, vehicle rental, flight, etc.) When generating a travel domain persona for the first user, the data fusion system 136 may determine whether the first user's favorite color is present in the received input from block 802 or already exists in the first domain persona (e.g., domain specific first party data 302). If not, the data fusion system 136 may solicit the first user's favorite color, such as by presenting an interface to the first user with a fillable area for the user's favorite color (e.g., through a user device 102).

At block 808, the data fusion system 136 may determine whether user feedback has been received. There may for example, be a timeout with respect to user feedback. If not, the data fusion system 136 may proceed to block 810. For example, with reference to the illustrative examples of FIGS. 7A-7B, if user input is not received within a specified period of time (e.g., five minutes, ten minutes, an hour, a day, etc.), the data fusion system may proceed to block 810.

At block 810, the data fusion system 136 may incorporate information in accordance with the recommended merge path. With reference to the illustrative example of FIG. 7A, for example, the data fusion system 136 may incorporate insight 706 and insight 712 into the travel domain persona for the first user. With reference to the illustrative example of FIG. 7B, the data fusion system 136 may leave the home address and airport unchanged in the travel domain persona in the absence of feedback from the first user, for example. As another example, the data fusion system may leave the home address and airport unchanged on receipt of positive feedback from the user (e.g., selection of a confirm link, selection of a submit button, etc.), as described with respect to block 420 of FIG. 4. The data fusion system 136 may alternatively update the home address and airport in the absence of feedback from the first user, for example.

The data fusion system 136 may, in some examples, include rules indicating how to reconcile discrepancies in the absence of user feedback. The rules may vary based on the discrepancy. Illustratively, with continued reference to FIG. 7B, for a home address discrepancy, the data fusion system 136 may include a rule indicating that the home address should be left unchanged in the absence of feedback from a first user. The data fusion system 136 may additionally, or alternatively, include a rule indicating that the airport should be updated in the absence of user feedback. The data fusion system 136 may update the travel domain persona for the first user in accordance with these rules in the absence of feedback from the first user.

The data fusion system 136 may, however, determine that user feedback has been received. At block 812, in accordance with the user feedback, the data fusion system 136 may generate an updated merge path. User input may not be received for all elements of a recommended merge path. For example, with continued reference to FIG. 7A, a user may provide feedback to edit or delete insight 706 but provide no feedback on insight 712. The data fusion system 136 may accordingly generate an updated merge path to incorporate insight 706 and subsequently incorporate insight 706 into the travel domain persona for the first user, for example. The data fusion system 136 may alternatively generate an updated merge path to incorporate insight 706 and not incorporate insight 712.

As another example, with continued reference to FIG. 7A, the first user may edit insight 706 to indicate that they enjoy North Indian Restaurants instead of South Indian Restaurants. The first user may, in further examples, indicate that insight 712 relating to interests in soccer and graphic novels should be deleted. Illustratively, the first user may have conducted those searches on behalf of another individual, such as an employer or a family member. Accordingly, the insight based on the search history, that the user has interests in soccer and graphic novels may be inaccurate. The first user may indicate that it is inaccurate by deleting the insight 712 in interface 702. The data fusion system 136 may accordingly generate an updated merge path to incorporate insight 706 as edited and exclude insight 712 from the travel domain persona for the first user.

As another example, with reference to FIG. 7B, the first user may provide feedback indicating that the home address and airport should be left unchanged, such as by selecting selectable area 714. The data fusion system 136 may accordingly generate an updated merge path to not modify the home address and airport in the travel domain persona for the first user.

At block 814, the data fusion system 136 may merge the information in accordance with the updated merge path. The data fusion system 136 may use the feedback incorporation system 142 in order to conduct the merge, as discussed with respect to FIG. 2. As discussed with respect to FIGS. 2-3, the first domain persona may be stored with a variety of data storage techniques. Merging information with the first domain persona may include updating structured data, such as a relational database (e.g., SQL table), to include the information in accordance with the updated merge path, for example. As another example, as described with respect to FIGS. 2-3, the first domain persona may be stored with a combination of structured and unstructured data storage techniques.

As another example, the first domain persona may be stored as an embedding, and merging information in accordance with the updated merge path may involve determining similarity (e.g., cosine similarity) between the information to be incorporated and the information already included in the first domain persona, for example. As discussed with respect to FIGS. 2-3, the first domain persona may be stored with structured data storage techniques, unstructured data storage techniques, or a combination of structured and unstructured data storage techniques.

At block 816, the data fusion system 136 may generate an updated domain persona. The updated domain persona may incorporate information in accordance with the recommended merge path as discussed with respect to block 810. The updated domain persona may additionally, or alternatively, include information incorporated with respect to an updated merge path, as discussed with respect to block 812. For example, with continued reference to FIG. 7A, the data fusion system 136 may receive user input with respect to insight 706 but not with respect to insight 712. The updated domain persona may thus include information incorporated with respect to both the updated and recommended merge path, as discussed with respect to block 812.

Once generated, the updated domain persona may be presented to the first user for further feedback. The data fusion system 136 may, for example, use the feedback incorporation system 142 and/or the display system 144 to generate an interface indicating the first domain persona has been updated per their feedback. The interface may be presented automatically or on user request.

With reference to FIG. 9A the interface may include an indication of data sources from which information in the first domain persona is derived. Illustratively, for a travel domain persona, first party data 904 may reflect data from a travel provider service that allows a user to search for and book travel items (e.g., hotels, vehicle rentals, flights, restaurant reservations, etc.) on a website or other interface (e.g., smartphone application). The travel provider service may, in some examples, be an administrator of the first domain persona system 114. As another example, the travel provider may be a third party system (e.g., third party system 118 of FIG. 1) that submits a request to link, and provide access to, a third party data ingestion service 106 as discussed with respect to FIG. 4 at block 404. In the illustrative example of FIG. 9A, first party data 904 is presented separately from linked data 906 as an example. However, in some examples, all data sources may be listed under the same heading. For example, first party data 904 may be listed as Platform C.

Linked data 906 may be platforms linked through the method 400 discussed with respect to FIG. 4. As discussed with respect to FIG. 1, the platforms included in linked data 906 may include, but are not limited to, entities corresponding to data portability APIs (e.g., travel providers, social media platforms, search providers, etc.), message parsing systems, data provider services, and the like, or some combination thereof.

From interface 900, the first user may request to link an additional platform by selecting selectable area 908. The first user may also select platforms that have already been linked in order to modify information included in the first domain persona. The first user may select platform A and be directed to interface 902 of FIG. 9B. On reaching interface 902, the user is presented with data items from platform A that are included in the first domain persona. As discussed with respect to FIG. 4 and FIG. 8, the data items may include, but are not limited to, subsets of raw data from platform A identified (e.g., by data intake system 116) as relevant to the domain for the first domain persona, generated insights based on the raw data, and/or insights. In interface 902, the first user may provide feedback to edit or delete the data items. This feedback may be handled by the data fusion system 136 (e.g., with the feedback incorporation system 142) and used in updating the first domain persona, as described with respect to FIG. 8.

While the above description indicates that the method 800 as being implemented by the data fusion system 136, for example. Different blocks may execute on various components of a domain persona system 114. By way of illustration, blocks 806 and 812 may be implemented, at least in part, with the display system 144 of FIG. 2.

### 4.4. Downstream Machine Learning Applications

FIG. 10 is a flow diagram illustrating a method 1000 to generate recommendations based on a domain persona. The recommendation system 115 may, in some examples, implement the method 1000. At block 1002, the recommendation system 115 may access a query that includes domain specific results associated with a first domain. The query may be accessed through user input into a search system (e.g., typed input, voice command, etc.). For example, a user may submit a query for shopping recommendations relating to art deco home décor items. The query may specify the user and the domain for the query. The query may additionally, or alternatively, come from a third party system (e.g., third party system 118 of FIG. 1). Illustratively, a third party system 118 may leverage the recommendation system 115 to respond to user queries. The third party system 118 may be a shopping website, for example. In further examples, the third party system 118 may send a query for art deco home décor items to the recommendation system 118 for analysis. As described with respect to FIG. 1, recommendation system 115 may be any system that provides search results, recommendations, reviews, the like, or some combination thereof.

The recommendation system 115 may additionally, or alternatively, access metadata for the query, where the metadata includes specification of the user and/or the domain. The query and/or the metadata may, for example, include a specified identifier for the user and/or an indication of the domain. With continued reference to the illustrative example, the recommendation system 115 may receive an identifier specifying the user who submitted the query for shopping recommendations relating to art deco décor items. The query relating to home décor shopping recommendations, metadata indicating that the query was submitted to a shopping platform, and the like, or some combination thereof, may indicate that the domain corresponding to the query is home décor shopping. The recommendation system 115 may thus determine the domain is home décor shopping and the specified user, such as with one or more machine learning models (e.g., LLMs)

At block 1004, the recommendation system 115 may access the domain persona representing the user and associated with the first domain. With continued reference to the illustrative example, the recommendation system 115 may request a domain persona from the domain persona system 114 for the specified user with respect to the first domain. The domain persona system 114 may then generate the domain persona using the methods 400 and 800 as described with respect to FIG. 4 or FIG. 8. Alternatively, the domain persona system 114 may have a domain persona for the specified user with respect to the first domain and may export the domain persona to the recommendation system 115. As another example, the recommendation system 115 may have previously accessed the domain persona for the specified user with respect to the first domain, such as by receiving the domain persona from the export system 148 of FIG. 1. The recommendation system 115 may store this in a data structure, such as any data structure described with respect to FIG. 3. On accessing the query at block 1002, the recommendation system 115 may access the data structure to retrieve the domain persona, such as by accessing a data location in the data structure including the domain persona.

At block 1006, the recommendation system 115 may generate query results responsive to the query received at 1002. The query results may be based on the domain persona accessed at 1104. With continued reference to the illustrative example of a specified user's query for art deco home décor items, the recommendation system 115 may generate query results including a list of art deco home décor items. The results may be based on the specified user's home décor domain persona. Illustratively, if the specified user's home décor domain persona includes an insight that the user likes clocks, the query may return clocks in an art deco style. Alternatively, the query generated by the recommendation system 115 may just include a list of art deco home décor items, which may be ordered based on the specified user's home décor domain persona at block 1008.

At block 1008, the recommendation system 115 may order search results for the user based on the domain persona. With continued reference to the illustrative example, based on the insight that the specified user likes clocks, the recommendation system 115 may order the query results such that clocks in the art deco style are presented to the user prior to other art deco home décor items responsive to the query.

At block 1010, the recommendation system 115 may output the ordered search results. For example, the recommendation system 115 may output ordered search results to a display of a user device 102 corresponding to the specified user, such as a user device 102 owned by the specified user.

Some of the processes, steps, and/or modules discussed herein with respect to FIG. 10 may be combined, separated into sub-parts, omitted entirely, and/or rearranged to run in a different order and/or in parallel. In addition, in some examples, different blocks may execute on different systems. Illustratively, while the above description indicates that the method 1000 as being implemented by the recommendation system 115, for example. The domain persona system 114 system may, as another example, generate and order query results based on a received query (e.g., from the specified user, from an external system, etc.) in accordance with method 1000. Illustratively, the domain persona system 114 may leverage the implementation system 146 to respond to queries. The domain persona system 114 may then output the search results to a user device 102 corresponding with the specified user, such as by using display system 144. Alternatively, a search system may be a co-owned entity with respect to domain persona system 114, as described with respect to FIG. 2 above. In further examples, the search system may be a travel recommendation system. The domain persona system 114 may therefore handle responding to queries relating to a specified user's travel domain persona, such as with the implementation system 146.

Queries relating to a specified user for other domains may be handled by different systems (e.g., recommendation system 115, third party systems 118, etc.) The domain persona system 114 may generate and provide domain personas to these different systems, but not handle responses to queries for them. By way of illustration, a third party system 118 may implement the method 1000. A request to generate the domain persona may, in some examples, come from a third party system 118. The domain persona system 114 may illustratively generate a domain persona for a specified user with respect to a specified domain. After generation of the domain persona, the domain persona system 114 may export the domain persona to the third party system 118 with the export system 148 using any of the techniques described herein with respect to FIG. 2.

Some of the processes, steps, and/or modules discussed herein with respect to FIG. 10 may be combined, separated into sub-parts, omitted entirely, and/or rearranged to run in a different order and/or in parallel. In addition, in some examples, different blocks may execute on different systems. Illustratively, while the above description indicates that the method 1000 as being implemented by the recommendation system 115, for example. The domain persona system 114 system may, for example, generate and order query results based on a received query (e.g., from the specified user, from an external system, etc.) in accordance with method 1000.

FIG. 11 is a flow diagram illustrating a method 1100 to generate travel recommendations based on a travel domain persona. Method 1100 by a recommendation system, such as recommendation system 115. As described with respect to FIG. 1, recommendation system 115 may be any system that provides search results, recommendations, reviews, the like, or some combination thereof. The recommendation system 115 may, in some examples, correspond to a travel search platform.

At block 1102, the recommendation system 115 may receive a travel search query for one or more travel items including, but not limited to, a hotel, a vehicle rental, a flight, and the like, or some combination thereof. The recommendation system 115 may, for example, receive a travel search query for hotels in Seattle. The query may correspond to a user, specified in the query and/or related metadata, as discussed with respect to FIG. 10 at block 1002. The specified user may correspond to an existing travel domain persona.

At block 1104, the recommendation system 115 may access the travel domain persona. The recommendation system 115 may, for example, store a version of the travel domain for the specified user in an existing data structure. By way of illustration, the domain persona system 114 may have previously exported a version of the travel domain persona for the specified user to the recommendation system 115, such as with the export system 148 of FIG. 1. If stored, the recommendation system 115 may access the travel domain in generating query results with respect to block 1006 and/or ordering search results for the specified user with respect to block 1008, for example. The recommendation system 115 may alternatively access the travel domain persona for the specified user with the domain persona system 114, such as by accessing a data location corresponding to the travel domain persona in multi-party domain persona database 130 of FIG. 1. For example, the recommendation system 115 may be a travel search platform and can be configured to access a generated travel domain persona in real time and/or as needed, such as when the specified user is searching for travel on the search platform. Illustratively, the recommendation system 115 may access the generated travel domain persona at a variety of time intervals (e.g., instantly, less than 1 second, etc.) after receipt of a travel query from a specified user. The recommendation system 115 may then use the travel domain persona to generate request to the travel query, as described herein.

At block 1106, the recommendation system 115 may use the travel search results responsive to the travel search query. With continued reference to the illustrative example, the specified user may be searching for hotels in Seattle. In further examples, if the travel domain persona for the specified user indicates that the user likes art museums, the recommendation system 115 may use this to define the search and accordingly return results that are around (e.g., within a mile) of art museums in Seattle.

At block 1108, the recommendation system 115 may order the search results for the specified user based on the travel domain persona. With continued reference to the illustrative example, the recommendation system 115 may place hotels closer to art museums higher in the order than hotels that are further away. Illustratively, a hotel 0.5 miles away from an art museum may be higher in the order than a second hotel 0.75 miles away from the art museum.

While FIG. 11 indicates that the recommendation system 115 may both generate search results at block 1106 based on the travel domain persona and order results at block 1108 based on the travel domain persona, for example. The recommendation system 115 may, in some examples, not utilize the travel domain persona in generating travel search results at block 1106. In further examples, the recommendation system 115 may use the travel domain persona in ordering the travel search results generated without utilizing the travel domain persona.

At block 1110, the recommendation system 115 may output the ordered travel search results. The recommendation system 115 may, for example, output the ordered travel search results through a user device 102 corresponding to the specified user.

At block 1112, the recommendation system 115 may facilitate booking of at least one of the travel search results. Illustratively, if the specified user selects one of the items in the travel search results through the user device 102, the recommendation system 115 may present the specified user with an interface including selectable options to book the travel item corresponding to the search result. With continued reference to the illustrative example, if the user selects a hotel in Seattle included in the travel search results output at block 1110, then the recommendation system 115 may cause an interface to be presented including selectable options to book a stay at the hotel.

Some of the processes, steps, and/or modules discussed herein with respect to FIG. 11 may be combined, separated into sub-parts, omitted entirely, and/or rearranged to run in a different order and/or in parallel. In addition, in some examples, different blocks may execute on different systems. Illustratively, while the above description indicates that the method 1100 as being implemented by the recommendation system 115, for example. The domain persona system 114 system may, for example, generate and order travel results based on a received travel search query (e.g., from the specified user, from an external system, etc.) in accordance with method 1100.

### V. Example Computing System

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.) The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some examples, the computer system may be a cloud-based computing system whose processing resources are shared by multiple distinct business entities or other users.

For example, FIG. 12 is a block diagram that illustrates a domain persona system 114 upon which various aspects of the present disclosure may be implemented. Domain persona system 114 includes a bus 1202 or other communication mechanism for communicating information, and a hardware processor, or multiple processors, 1204 coupled with bus 1202 for processing information. Hardware processor(s) 1204 may be, for example, one or more general purpose microprocessors.

Domain persona system 114 also includes a main memory 1206, such as a random access memory (RAM), cache and/or other dynamic storage devices, coupled to bus 1202 for storing information and instructions to be executed by processor 1204. Main memory 1206 also may be used for storing temporary variables or other intermediary information during execution of instructions to be executed by processor 1204. Such instructions, when stored in storage media accessible to processor 1204, render domain persona system 114 into a special-purpose machine that is customized to perform the operations specified in the instructions.

Domain persona system 114 further includes a read only memory (ROM) 1208 or other static storage device coupled to bus 1202 for storing static information and instructions for processor 1204. A storage device 1210, such as a magnetic disk, optical disk, or USB thumb drive (Flash drive), etc., is provided and coupled to bus 1202 for storing information and instructions.

Domain persona system 114 may be coupled via bus 1202 to a display 1212, such as a cathode ray tube (CRT) or LCD display (or touch screen), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. In some examples, the same direction information and command selections as cursor control may be implemented via receiving touches on a touch screen without a cursor.

Domain persona system 114 may include a user interface module to implement a GUI that may be stored in a mass storage device as computer executable program instructions that are executed by the computing device(s). Domain persona system 114 may further, as described herein, implement the techniques described herein using customized hard-wired logic, one or more ASICs or FPGAs, firmware and/or program logic which in combination with the computer system causes or programs domain persona system 114 to be a special-purpose machine. According to one example, the techniques herein are performed by domain persona system 114 in response to processor(s) 1204 executing one or more sequences of one or more computer readable program instructions contained in main memory 1206. Such instructions may be read into main memory 1206 from another storage medium, such as storage device 1210. Execution of the sequences of instructions contained in main memory 1206 causes processor(s) 1204 to perform the process steps described herein. In alternative examples, hard-wired circuitry may be used in place of or in combination with software instructions.

Various forms of computer readable storage media may be involved in carrying one or more sequences of one or more computer readable program instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to domain persona system 114 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Domain persona system 114 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN (or WAN component to communicated with a WAN). Wireless links may also be implemented. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the worldwide packet data communication network now commonly referred to as the “Internet” 1228. Local network 1222 and Internet 1228 both use electrical, electromagnetic, or optical signals that carry digital data streams. The signals through the various networks and the signals on network link 1220 and through communication interface 1218, which carry the digital data to and from domain persona system 114, are example forms of transmission media.

Domain persona system 114 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

### VI. Additional Implementation Details, Terminology, and Aspects

To facilitate an understanding of the systems and methods discussed herein, several terms are described herein. These terms, as well as other terms used herein, should be construed to include the provided descriptions, the ordinary and customary meanings of the terms, and/or any other implied meaning for the respective terms, wherein such construction is consistent with context of the term. Thus, the descriptions herein do not limit the meaning of these terms, but only provide example descriptions.

The term “model” or ML model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, ML models, multimodal models (e.g., models or combinations of models that can accept inputs of multiple modalities, such as images and text), and/or the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

An LLM is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodel LLM/model, and/or the like. An LLM (and/or other models of the present disclosure), may include, for example, attention-based and/or transformer architecture or functionality.

While certain aspects and implementations are discussed herein with reference to use of a language model, LLM, and/or AI, those aspects and implementations may be performed by any other language model, LLM, AI model, generative AI model, generative model, ML model, NN, multimodel model, and/or other algorithmic processes. Similarly, while certain aspects and implementations are discussed herein with reference to use of a ML model, those aspects and implementations may be performed by any other AI model, generative AI model, generative model, NN, multimodel model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), and BigScience Large Open-science Open-access Multilingual Language Model (BLOOM).

Although the terms machine learning and/or artificial intelligence are used herein, the scope of each term shall include each and every type of machine learning, artificial intelligence, neural network, and the like, known to a person of ordinary skill in the art. An AI or ML model can be built or trained based on sample data or training data in order to make predictions or decisions without being explicitly programmed to do so. In some examples, machine learning algorithms, models, and/or programs can perform tasks without being explicitly programmed to do so. For example, some aspects of the present disclosure may include training an AI/ML model in a computer to carry out certain desired tasks that a human may not be able to manually perform.

A number of different types of AI/ML algorithms and AI/ML models or approaches may be used by the machine learning component to implement the models. For example, certain examples herein may use a logistical regression model, decision trees, random forests, convolutional neural networks, deep networks, or others. However, other models are possible, such as a linear regression model, a discrete choice model, or a generalized linear model. The machine learning aspects can be configured to adaptively develop and update the models over time based on new input. For example, the models can be trained, retrained, or otherwise updated on a periodic basis as new received data is available to help keep the predictions in the model more accurate as the data is collected over time. Also, for example, the models can be trained, retrained, or otherwise updated based on configurations received from a user, admin, or other devices. Some non-limiting examples of machine learning algorithms that can be used to train, retrain, or otherwise update the models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), support-vector machines, federated learning, and/or other machine learning algorithm. These machine learning algorithms may include any type of machine learning algorithm including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of received data may be analyzed to generate or implement models with minimal, or with no, manual analysis or review by one or more people.

In some examples, supervised learning algorithms can build a mathematical model of a set of data that contains both the inputs and the desired outputs. For example, training data can be used, which comprises a set of training or labeled/annotated examples. Each training example has one or more inputs and the desired output, also known as a supervisory signal. In the mathematical model, for example, each training example is represented by an array or vector (e.g., a feature vector), and the training data is represented by a matrix. Through iterative optimization of an objective function, supervised learning algorithms can learn a function that can be used to predict the output associated with new inputs. An optimal function, for example, can allow the algorithm to correctly determine the output for inputs that were not a part of the training data. For instance, an algorithm that improves the accuracy of its outputs or predictions over time is said to have learned to perform that task. Types of supervised-learning algorithms may include, but are not limited to active learning, classification, and regression. Classification algorithms, for example, are used when the outputs are restricted to a limited set of values. Regression algorithms, for example, are used when the outputs may have any numerical value within a range. As an example, for a classification algorithm that filters emails, the input would be an incoming email, and the output would be the name of the folder in which to file the email. In some examples, similarity learning, an area of supervised machine learning, is closely related to regression and classification, but the goal is to learn from examples using a similarity function that measures how similar or related two objects are. In some examples, similarity learning has applications in ranking, recommendation systems, visual identity tracking, face verification, and speaker verification.

In some examples, unsupervised learning algorithms can take a set of data that contains only inputs, and find structure in the data, like grouping or clustering of data points. For example, the algorithms can learn from test data that has not been labeled, classified, or categorized. Instead of responding to feedback, unsupervised learning algorithms can identify commonalities in the data and react based on the presence or absence of such commonalities in each new piece of data. In some examples, unsupervised learning encompasses summarizing and explaining data features. In some examples, cluster analysis is the assignment of a set of observations into subsets (e.g., clusters) so that observations within the same cluster are similar according to one or more predesignated criteria, while observations drawn from different clusters are dissimilar. In some cases, different clustering techniques can make different assumptions on the structure of the data, often defined by some similarity metric and evaluated, for example, by internal compactness, or the similarity between members of the same cluster, and separation, the difference between clusters. Other methods, for example, can be based on estimated density and graph connectivity.

In some examples, semi-supervised learning can be a combination of unsupervised learning (without any labeled training data) and supervised learning (with completely labeled training data). For example, some of the training examples may be missing training labels, and in some cases such training examples can produce a considerable improvement in learning accuracy as compared to supervised learning. In some examples, and in weakly supervised learning, the training labels can be noisy, limited, or imprecise; however, these labels are often cheaper to obtain, resulting in larger effective training sets.

In some examples, an area of machine learning is concerned with how software agents ought to take actions in an environment so as to maximize some notion of cumulative reward. In some examples, the environment is typically represented as a Markov decision process (MDP). In some examples, reinforcement learning algorithms use dynamic programming techniques. In some examples, reinforcement learning algorithms do not assume knowledge of an exact mathematical model of the MDP and are used when exact models are infeasible.

In addition to supervised learning algorithms, unsupervised learning algorithms, and semi-supervised learning, and in some examples, other types of machine learning methods can be implemented, such as: reinforcement learning (e.g., how software agents ought to take actions in an environment so as to maximize some notion of cumulative reward); dimensionality reduction (e.g., process of reducing the number of random variables under consideration by obtaining a set of principal variables); self-learning (e.g., learning with no external rewards and no external teacher advice); feature learning or representation learning (e.g., preserve information in their input but also transform it in a way that makes it useful); anomaly detection or outlier detection (e.g., identification of rare items, events or observations which raise suspicions by differing significantly from the majority of the data); association rules (e.g., discovering relationships between variables in large databases); and/or the like.

Additionally, depending on the example, certain acts, events, or functions of any of the processes or algorithms described herein can be performed in a different sequence, can be added, merged, or left out altogether (e.g., not all described operations or events are necessary for the practice of the algorithm). Moreover, in certain examples, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the examples disclosed herein can be implemented as electronic hardware, or combinations of electronic hardware and computer software. To clearly illustrate this interchangeability, various illustrative components, blocks, modules, and steps have been described herein generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some examples, the computer system may be a cloud-based computing system whose processing resources are shared by multiple distinct business entities or other users.

Depending on the example, certain acts, events, or functions of any of the processes or algorithms described herein can be performed in a different sequence, can be added, merged, or left out altogether (e.g., not all described operations or events are necessary for the practice of the algorithm). Moreover, in certain examples, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the examples disclosed herein can be implemented as electronic hardware, or combinations of electronic hardware and computer software. To clearly illustrate this interchangeability, various illustrative components, blocks, modules, and steps have been described herein generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the examples disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another example, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the examples disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without other input or prompting, whether these features, elements and/or steps are included or are to be performed in any particular example. The terms “comprising,” “including,” “having,” and the like, are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the herein detailed description has shown, described, and pointed out novel features as applied to various examples, it can be understood that various omissions, substitutions, and changes in the form and details of the devices or algorithms illustrated can be made without departing from the spirit of the disclosure. As can be recognized, certain examples described herein can be embodied within a form that does not provide all of the features and benefits set forth herein, as some features can be used or practiced separately from others. The scope of certain examples disclosed herein is indicated by the appended claims rather than by the foregoing description. All changes which come within the meaning and range of equivalency of the claims are to be embraced within their scope.

Some inventive aspects of the disclosure are set forth in the following clauses:
Clause 1. A computer-implemented method comprising:
   based at least in part on receipt of a first input comprising a first subset of data indicative of first preferences of a first user with respect to a first domain, generating a first merge path that includes a plan to execute instructions configured to generate or update a first domain persona based on the first subset of data;
   providing, to a first user device corresponding to the first user, at least a portion of the first merge path;
   receiving, from the first user device, feedback with respect to the first merge path;
   based on the received feedback, generating an updated merge path that includes an updated plan; and
   executing the updated plan to generate or update the first domain persona.
Clause 2. The computer-implemented method of Clause 1, further comprising:
   based at least in part on receipt of a second input comprising a second subset of data indicative of a first user's preferences with respect to a second domain, generating a second merge path that includes a second plan to execute instructions configured to generate or update a second domain persona based on the second subset of data;
   providing, to the first user device corresponding to the first user, at least a portion of the second merge path;
   receiving, from the first user device, feedback with respect to the second merge path;
   based on the received feedback, generating a second updated merge path that includes a second updated plan; and
   executing the second updated plan to generate or update the second domain persona.
Clause 3. The computer-implemented method of any of Clauses 1 to 2, further comprising:
   based at least in part on receipt of a second input comprising a second subset of data indicative of a first user's preferences with respect to the first domain, generating a second merge path that includes a second plan to execute instructions configured to update the first domain persona based on the second subset of data; and
   providing, to the first user device corresponding to the first user, at least a portion of the second merge path.
Clause 4. The computer-implemented method of Clause 3, further comprising:
   receiving, from the first user device, feedback with respect to the second merge path;
   based on the received feedback, generating an updated merge path that includes an second updated method to incorporate the second subset of data into the first domain persona; and
   executing the second updated plan to update the first domain persona.
Clause 5. The computer-implemented method of Clause 3, further comprising:
   failing to receive feedback from the first user on the second merge path; and executing the second plan to update the first domain persona.
Clause 6. The computer-implemented method of any of Clauses 1 to 5, wherein the instructions configured to generate or update a first domain persona based on the first subset of data include instructions to modify the first domain persona by manipulating a data item within the first subset, wherein manipulating a data item within the first subset comprises at least one of adding, removing, or modifying the data item.
Clause 7. The computer-implemented method of any of Clauses 1 to 5, further comprising:
   based at least in part on receipt of a second input comprising a second subset of data indicative of preferences of a second user with respect to the first domain, generating a second merge path that includes a plan to execute instructions configured to generate or update a second domain persona based on the second subset of data;
   providing, to a second user device corresponding to the second user, at least a portion of the second merge path;
   receiving, from the second user device, feedback with respect to the second merge path;
   based on the received feedback, generating a second updated merge path that includes a second updated plan; and
   executing the second updated plan to generate or update the second domain persona.
Clause 8. The computer-implemented method of any of Clauses 1 to 7, wherein the first domain is travel.
Clause 9. A system comprising:
   a memory to store specific computer-executable instructions;
   a processor in communication with the memory wherein the processor executes the specific computer-executable instructions to at least perform the computer-implemented method of any of Clauses 1 to 8.
Clause 10. A non-transitory computer-readable medium storing instructions that, when executed, cause a computing system to perform operations of the computer-implemented method of any of Clauses 1 to 8.
Clause 11. A computer-implemented method comprising:
   receiving, from a first user system corresponding to a first user, a first request comprising a first domain;
   in response to receiving the first request, accessing, via an ingestion service electronically connected to one or more third party databases, third party user data corresponding to the first user, wherein the ingestion service includes data corresponding to online behavior of the first user;
   identifying and accessing, from one or more databases, a first domain persona corresponding to the first user, wherein the first domain persona includes an indication of first user preferences of the first user with respect to the first domain,
   identifying and accessing, via the ingestion service and from one or more third party databases, a first subset of data that is determined to be relevant or indicative of the first user preferences;
   generating insights based at least in part on the first subset of data; and
   electronically transmitting at least one portion of the insights to a data fusion system that is configured to:
      generate an updated first domain persona based at least in part on the at least one portion of the insights.
Clause 12. The computer-implemented method of Clause 11, further comprising implementing a fraud detection service to determine that that a likelihood of fraud with respect to the first request is below a specified threshold.
Clause 13. The computer-implemented method of Clause 12, wherein determining that the likelihood of fraud with respect to the first request is below a specified threshold, further comprises:
   determining timestamps associated with one or more data items included in the first subset of data;
   determining an amount of data items included in the first subset of data indicating a user's online behavior with respect to the first domain; and
   based on the timestamps and the amount of data items, determining that the likelihood of fraud with respect to the first request is below a specified threshold.
Clause 14. The computer-implemented method of any of Clauses 11 to 13, further comprising: implementing a relevancy service to determine that the first subset of data is relevant or indicative of user preferences at least by determining that a relevancy score for each data item within the first subset of data is above a threshold.
Clause 15. The computer-implemented method of any of Clauses 11 to 14, wherein the first domain persona includes at least one of: first information determined to be relevant to the first user preferences or generated insights based on the first information.
Clause 16. The computer-implemented method of any of Clauses 11 to 15, wherein identifying and accessing, from the one or more databases, a first domain persona corresponding to the first user, further comprises:
   determining that the first domain persona exists; and
   accessing the first domain persona.
Clause 17. The computer-implemented method of any of Clauses 11 to 16, wherein identifying and accessing, from the one or more databases, a first domain persona corresponding to the first user, further comprises:
   determining that the first domain persona does not exist;
   generating the first domain persona including a specification of the first user and a specification of the first domain; and
   accessing the first domain persona.
Clause 18. A system comprising:
   a memory to store specific computer-executable instructions;
   a processor in communication with the memory wherein the processor executes the specific computer-executable instructions to at least perform the computer-implemented method of any of Clauses 11 to 17.
Clause 19. A non-transitory computer-readable medium storing instructions that, when executed, cause a computing system to perform operations of the computer-implemented method of any of Clauses 11 to 17.
Clause 20. A computer-implemented method comprising:
   accessing a query requesting domain specific results associated with a first domain;
   accessing a domain persona representing a user associated with the first domain;
   generating query results based on the domain persona;
   ordering search results for the user based on the domain persona; and
   outputting ordered search results.
Clause 21. The computer-implemented method of Clause 20, wherein the domain persona includes structured and unstructured data.
Clause 22. The computer-implemented method of any of Clauses 20 to 21, wherein the first domain is travel.
Clause 23. The computer-implemented method of Clause 22, wherein the query comprises a request for a travel item, wherein the travel item is at least one of a hotel, a car rental, or a flight.
Clause 24. The computer-implemented method of Clause 22, wherein the ordered search results comprise at least one travel item, wherein the at least one travel item is at least one of a hotel, a car rental, or a flight.
Clause 25. The computer-implemented method of Clause 24, further comprising facilitating a booking of the at least one travel item.
Clause 26. The computer-implemented method of any of Clauses 20 to 25, wherein the first domain includes at least one of shopping, hobbies, travel, business travel, or leisure travel.
Clause 27. A system comprising:
   a memory to store specific computer-executable instructions;
   a processor in communication with the memory wherein the processor executes the specific computer-executable instructions to at least perform the computer-implemented method of any of Clauses 20 to 26.

Clause 28. A non-transitory computer-readable medium storing instructions that, when executed, cause a computing system to perform operations of the computer-implemented method of any of Clauses 20 to 26.

What is claimed is:

1. A system comprising:
a memory to store specific computer-executable instructions;
a processor in communication with the memory wherein the processor executes the specific computer-executable instructions to at least:
receive, from a first user system corresponding to a first user, a first request comprising permission to access third party user data and a first domain;
in response to receiving the first request, access, via an ingestion service electronically connected to one or more third party databases, third party user data corresponding to the first user, wherein the ingestion service includes data corresponding to online behavior of the first user;
identify and access, from the memory, a first domain persona corresponding to the first user, wherein the first domain persona includes an indication of first user preferences of the first user with respect to the first domain,
identify and access, via the ingestion service and from one or more third party databases, a first subset of data that is determined to be relevant or indicative of the first user preferences;
generate insights based at least in part on the first subset of data; and
electronically transmit at least one portion of the insights to a data fusion system that is configured to:
generate an updated first domain persona based at least in part on the at least one portion of the insights.

2. The system of claim 1, wherein the processor executes further specific computer executable instructions to at least implement a fraud detection service to determine that that a likelihood of fraud with respect to the first request is below a specified threshold.

3. The system of claim 2, wherein, to determine that the likelihood of fraud with respect to the first request is below a specified threshold, the processor executes execute further specific computer executable instructions to at least:
determine timestamps associated with one or more data items included in the first subset of data;
determine an amount of data items included in the first subset of data indicating a user's online behavior with respect to the first domain; and
based on the timestamps and the amount of data items, determine that the likelihood of fraud with respect to the first request is below a specified threshold.

4. The system of claim 1, wherein the processor executes further specific computer executable instructions to at least implement a relevancy service to determine that the first subset of data is relevant or indicative of user preferences at least by determining that a relevancy score for each data item within the first subset of data is above a threshold.

5. The system of claim 1, wherein the first domain persona includes at least one of: first information determined to be relevant to the first user preferences or generated insights based on the first information.

6. The system of claim 1, wherein, to identify and access, from the memory, a first domain persona corresponding to the first user, the processor executes further specific computer executable instructions to at least:
determine that the first domain persona exists; and
access the first domain persona.

7. The system of claim 1, wherein, to identify and access, from the memory, a first domain persona corresponding to the first user, the processor executes further specific computer executable instructions to at least:
determine that the first domain persona does not exist;
generate the first domain persona including a specification of the first user and a specification of the first domain; and
access the first domain persona.

8. The system of claim 1, wherein the first domain is travel.

9. The system of claim 1, wherein the first domain is business travel.

10. A computer-implemented method comprising:
receiving, from a first user system corresponding to a first user, a first request comprising a first domain;
in response to receiving the first request, accessing, via an ingestion service electronically connected to one or more third party databases, third party user data corresponding to the first user, wherein the ingestion service includes data corresponding to online behavior of the first user;
identifying and accessing, from one or more databases, a first domain persona corresponding to the first user, wherein the first domain persona includes an indication of first user preferences of the first user with respect to the first domain,
identifying and accessing, via the ingestion service and from one or more third party databases, a first subset of data that is determined to be relevant or indicative of the first user preferences;
generating insights based at least in part on the first subset of data; and
electronically transmitting at least one portion of the insights to a data fusion system that is configured to:
generate an updated first domain persona based at least in part on the at least one portion of the insights.

11. The computer-implemented method of claim 10, further comprising implementing a fraud detection service to determine that that a likelihood of fraud with respect to the first request is below a specified threshold.

12. The computer-implemented method of claim 11, wherein determining that the likelihood of fraud with respect to the first request is below a specified threshold, further comprises:
determining timestamps associated with one or more data items included in the first subset of data;
determining an amount of data items included in the first subset of data indicating a user's online behavior with respect to the first domain; and
based on the timestamps and the amount of data items, determining that the likelihood of fraud with respect to the first request is below a specified threshold.

13. The computer-implemented method of claim 10, further comprising: implementing a relevancy service to determine that the first subset of data is relevant or indicative of user preferences at least by determining that a relevancy score for each data item within the first subset of data is above a threshold.

14. The computer-implemented method of claim 10, wherein the first domain persona includes at least one of: first information determined to be relevant to the first user preferences or generated insights based on the first information.

15. The computer-implemented method of claim 10, wherein identifying and accessing, from the one or more databases, a first domain persona corresponding to the first user, further comprises:
determining that the first domain persona exists; and
accessing the first domain persona.

16. The computer-implemented method of claim 10, wherein identifying and accessing, from the one or more databases, a first domain persona corresponding to the first user, further comprises:
determining that the first domain persona does not exist;
generating the first domain persona including a specification of the first user and a specification of the first domain; and
accessing the first domain persona.

17. A non-transitory computer-readable medium storing instructions that, when executed, cause a computing system to perform operations comprising:
receiving, from a first user system corresponding to a first user, a first request comprising a first domain;
in response to receiving the first request, accessing, via an ingestion service electronically connected to one or more third party databases, third party user data corresponding to the first user, wherein the ingestion service includes data corresponding to online behavior of the first user;
identifying and accessing, from one or more databases, a first domain persona corresponding to the first user, wherein the first domain persona includes an indication of first user preferences of the first user with respect to the first domain,
identifying and accessing, via the ingestion service and from one or more third party databases, a first subset of data that is determined to be relevant or indicative of the first user preferences;
generating insights based at least in part on the first subset of data; and
electronically transmitting at least one portion of the insights to a data fusion system that is configured to:
generate an updated first domain persona based at least in part on the at least one portion of the insights.

18. The non-transitory computer-readable medium of claim 17, wherein the instructions, when executed, further cause a computing system to perform operations comprising implementing a fraud detection service to determine that that a likelihood of fraud with respect to the first request is below a specified threshold.

19. The non-transitory computer-readable medium of claim 18, wherein, to determine that the likelihood of fraud with respect to the first request is below a specified threshold, the instructions, when executed, further cause a computing system to perform operations comprising:
determining timestamps associated with one or more data items included in the first subset of data;
determining an amount of data items included in the first subset of data indicating a user's online behavior with respect to the first domain; and
based on the timestamps and the amount of data items, determining that the likelihood of fraud with respect to the first request is below a specified threshold.

20. The non-transitory computer-readable medium of claim 17, wherein the instructions, when executed, further cause a computing system to perform operations comprising:
implementing a relevancy service to determine that the first subset of data is relevant or indicative of user preferences at least by determining that a relevancy score for each data item within the first subset of data is above a threshold.
